(19) United States
(12) Patent Application Publication
(10) Pub. No.: US 2020/0323382 A1
(43) Pub. Date: Oct. 15, 2020

(54) Multi-Stage Cooking System

(71) Applicant: Zhengxu He, Reno, NV (US)

(72) Inventor: Zhengxu He, Reno, NV (US)

(21) Appl. No.: 16/735,834

(22) Filed: Jan. 7, 2020

Related U.S. Application Data
(63) Continuation-in-part of application No. 16/510,982, filed on Jul. 15, 2019.
(60) Provisional application No. 62/833,005, filed on Apr. 12, 2019.

(51) Int. Cl. A47J 27/12; A47J 36/32; A47J 37/12; A47J 37/10

(52) U.S. Cl. CPC A47J 27/12; A47J 37/10; A47J 37/1228; A47J 36/32

(57) ABSTRACT

The present application firstly discloses a cooking system comprising more than one cooking apparatuses, each capable of producing a food from food ingredients. A semi-cooked food is produced in a cooking apparatus and is used as ingredient in another cooking apparatus. The cooking apparatuses work together to produce cooked food from food ingredients. A computer system is used to control the cooking system.

### CROSS-REFERENCE TO RELATED APPLICATIONS

This application is a continuation-in-part of U.S. application Ser. No. 16/510,982, filed Jul. 15, 2019 which claimed the benefit of U.S. Provisional Application Ser. No. 62/833,005, filed Apr. 12, 2019. Entire contents of the above applications are incorporated herein by reference.

US PROVISIONAL PATENT APPLICATIONS:

Ser. No. 62/833,005, Filed Apr. 12, 2019, Inventor: Zhengxu

US PATENT APPLICATIONS

Ser. No. 16/510,982, Filed Jul. 15, 2019, Inventor: Zhengxu He

Ser. No. 15/839,600, Filed Dec. 12, 2017, Inventor: Zhengxu He

Ser. No. 15/924749, Filed Mar. 19, 2018, Inventor: Zhengxu He

Ser. No. 16/155,895, Filed Oct. 10, 2018, Inventor: Zhengxu He

### BACKGROUND OF THE INVENTION

The present application relates to a cooking system for producing a food from food ingredients.

In cooking of a food item, one or more of the following steps are required: (1) a first food ingredient is stir fried or otherwise cooked in a wok or other cookware; (2) a second food ingredient is deep fried in hot oil or boiled in hot water; (3) a third food ingredient deep fried in hot oil is boiled in hot water; (4) the second and/or third food ingredients, after being deep fried in oil and boiled in hot water, are dispensed into the wok, adding to the third food ingredient; (5) all food ingredients are then stirred and/or mixed in the wok, as to produce a cooked food; (6) the cooked food is then dispensed into a food container, such as, a plate or a bowl.

A cost-effective cooking apparatus or cooking system that does (some or) all of the above steps is very important, as it can save labor and cost.

Furthermore, a cost-effective transportation of the first, second and third food ingredients to the deep fryer, hot water cookware or wok, respectively, is also very important for the same reason.

The automation of such cooking system depends on new computer algorithms.

### BRIEF SUMMARY OF THE INVENTION

A cooking system in our application comprises some cooking apparatuses and other mechanisms and/or apparatuses. The present patent application discloses some cooking apparatuses comprising one or more of the following parts: (1) a first cookware configured to contain or otherwise hold food or food ingredients for the purpose of cooking a food. (2) a motion apparatus comprising a stirring mechanism configured to move the first cookware as to stir or mix the food ingredients contained in the cookware and an unloading mechanism configured to directly or indirectly move the first cookware, as to dispense a cooked food into a food container; (3) a receiving mechanism configured to hold a food container as to allow said unloading mechanism to dispense a cooked food from the first cookware into a food container; (4) a second cookware configured to contain or otherwise hold food or food ingredients, a motion apparatus configured to move the second cookware, said motion apparatus may be used to dispense a semi-cooked food held in the second cookware to the first cookware; (5) a liquid container configured to hold a liquid (e.g., cooking oil, water) and a heater configured to heat the liquid therein, and a basket configured to contain or otherwise hold solid food or food ingredients.

The first cookware may be a wok, a pan, or any container configured to contain or otherwise hold food or food ingredients during cooking. The second cookware may be a wok, a pan, a basket, etc.

Implementations of our cooking system may include one or more of the following. The stirring mechanism may comprise a support component and a mechanism configured to produce a motion in the cookware relative to the support component, as to stir or mix the food or food ingredients in the cookware. The stirring mechanism may comprise: a first shaft; a second shaft; a third shaft; a fourth shaft; and a fifth shaft; wherein the axes of the shafts may be configured to be parallel to each other.

Implementations of our cooking system may include one or more of the following. The unloading mechanism is configured to produce an axial rotation in the support component of said stirring mechanism as to dispense a cooked food from the cookware; wherein the axis of the axial rotation is configured to be horizontal. The receiving apparatus may also comprise a funnel, a rotatable turntable configured to hold a food container (e.g., a bowl), and a cleaning mechanism configured to clean the funnel by spraying water or other cleaning liquid on the area to be cleaned.

Our cooking system may further comprise a dispensing mechanism which dispenses food or food ingredients into the first cookware and/or the second cookware. The cooking system may also comprise: a receiving apparatus which may hold a food container as to receive a cooked food from the first cookware; and a transfer apparatus which may move a container of cooked food to an area accessible by humans.

Implementations of our cooking system may include one or more of the following. A dispensing mechanism may comprise: (1) a gripping mechanism comprising a first support component, gripping devices, and a motion mechanism configured to produce a controlled rotation in said gripping device relative to the first support component as to grab or let loose a container; (2) a second support component; (3) a motion mechanism configured to produce a rotation in the first support component relative to the second support component.

A computer is used to control the above described mechanisms and apparatus.

### BRIEF DESCRIPTION OF THE SEVERAL VIEWS OF THE DRAWINGS

FIG. 1 shows an aerial view of a computer system.

FIG. 2 shows an aerial view of a cooking apparatus comprising a cookware and a stirring mechanism.

FIG. 3 shows an aerial view of the stirring mechanism.

FIG. 4 shows an aerial view of a cooking apparatus comprising the cooking apparatus of FIG. 2 and an unloading mechanism.

FIG. 5 shows an aerial view of the relative positioning of a receiving apparatus.

FIGS. 6A-6B show aerial views of the relative positions of the cooking apparatus of FIG. 4 and the receiving apparatus of FIG. 5.

FIG. 7A shows an aerial view of a liquid dispensing mechanism. FIG. 7B shows an aerial view of a lid apparatus comprising the liquid dispensing mechanism. FIGS. 7C-7D show aerial views of the relation positions of the cooking apparatus of FIG. 4 and the lid apparatus.

FIGS. 8A-8B show aerial views of a cookware cleaning mechanism. FIGS. 8C-8D show aerial views of the relative positions of the cookware cleaning mechanism and the cooking apparatus of FIG. 4.

FIG. 9A shows an aerial view of an ingredient dispensing mechanism

FIGS. 9B-9E show aerial views of parts of a transport system. FIG. 9F shows an aerial view of the transport system. FIG. 9G shows an aerial view of the relative positions of the transport system and the ingredient dispensing mechanism of FIG. 9A.

FIG. 10 shows an aerial view of the relative positions of the cooking apparatus of FIG. 4, the ingredient dispensing mechanism of FIG. 9A and the transport system of FIG. 9F.

FIG. 11A shows an aerial view of a cooking apparatus. FIG. 11B shows an aerial view of another cooking apparatus.

FIG. 12 shows an aerial view of a cooking apparatus.

FIGS. 13A-13B show aerial views of a cooking apparatus comprising the cooking apparatus of FIG. 11A and the cooking apparatus of FIG. 12.

FIG. 14 shows an aerial view of a cooking system comprising a transport system, a basket, a cookware and a food container. FIG. 15A shows an aerial view of the cooking system showing the dispensing of food ingredients from an ingredient container on the transport system into a basket; and FIG. 15B shows an aerial view of a zooming in view of the dispensing. FIG. 16A shows an aerial view of the cooking system showing the dispensing of a semi-cooked food from a basket to the cookware. FIG. 16B shows an aerial view of a zooming in view of the dispensing. FIG. 17 shows an aerial view of the cooking system showing the dispensing of a cooked food from a cookware to a food container.

FIG. 18 is a flow chart showing the procedures of the computer system of the cooking system of FIG. 14 prior to cooking of a food.

FIG. 19 is a flow chart showing the procedures of the computer system in the cooking system of FIG. 14 during the cooking of a food.

FIG. 20 shows a plane view of a positioning of various mechanisms and apparatuses in the cooking system of FIG. 14.

FIG. 21 shows an aerial view of a storage apparatus which can store ingredient containers.

FIG. 22 shows an aerial view of a loading mechanism

FIGS. 23A-23D show aerial views of the relative positions of the storage apparatus of FIG. 21, the loading mechanism of FIG. 22, and the transport system of FIG. 9F.

FIG. 24 shows an aerial view of a cooking system comprising two cookware and two stirring mechanisms. FIG. 25 shows an aerial view of the dispensing of a semi-cooked food from one cookware to another.

FIG. 26 is a flow chart showing the procedures of the computer system of the cooking system of FIG. 24 prior to cooking a food.

FIG. 27 is a flow chart showing the procedures of the computer system in the cooking system of FIG. 24 during the cooking of a food.

FIG. 28 shows a plane view of a positioning of various mechanisms and apparatuses in the cooking system of FIG. 24.

FIG. 29 shows an aerial view of a cooking system comprising a transport system, two baskets, a cookware and a food container.

FIG. 30A shows an aerial view of the cooking system of FIG. 29 showing the dispensing of food ingredients from an ingredient container on the transport system into one basket; and FIG. 30B shows an aerial view of a zooming in view of the dispensing. FIG. 30C shows an aerial view of the cooking system showing the dispensing of food ingredients from an ingredient container on the transport system into the other basket; and FIG. 30D shows an aerial view of a zooming in view of the dispensing.

FIG. 31A shows an aerial view of the cooking system of FIG. 29 showing the dispensing of a semi-cooked food from one basket to the cookware. FIG. 31B shows an aerial view of a zooming in view of the dispensing. FIG. 31C shows an aerial view of the cooking system showing the dispensing of a semi-cooked food from the other basket to the cookware. FIG. 31D shows an aerial view of a zooming in view of the dispensing.

FIG. 32 shows an aerial view of the cooking system of FIG. 29 showing the dispensing of a cooked food from a cookware to a food container.

FIG. 33 is a flow chart showing the procedures of the computer system of the cooking system of FIG. 29 prior to cooking of a food.

FIG. 34 is a flow chart showing the procedures of the computer system in the cooking system of FIG. 29 during the cooking of a food.

FIG. 35 shows a schematic plane view of the cooking system of FIG. 29.

FIG. 36 shows an aerial view of the cooking system of FIG. 29.

FIGS. 37A-37B show aerial views of a cooking apparatus comprising the cooking apparatus of FIG. 11B and the cooking apparatus of FIG. 12. FIG. 38A shows an aerial view of the cooking system showing the dispensing of food ingredients from an ingredient container on the transport system into a basket; and FIG. 38B shows a zooming in view of the dispensing. FIG. 39A shows an aerial view of the cooking system showing the dispensing of a semi-cooked food from the basket to the cookware. FIG. 39B shows an aerial view of a zooming in view of the dispensing.

FIG. 40 shows an aerial view of the cooking system showing the dispensing of a cooked food from a cookware to a food container.

FIG. 41 shows a plane view of a positioning of various mechanisms and apparatuses in the cooking system of FIG. 38A.

FIG. 42 shows an aerial view of a cooking system showing the dispensing of a semi-cooked food from a basket to the cookware.

FIG. 43 is a flow chart showing the procedures of the computer system of the cooking system of FIG. 42 prior to cooking of a food.

FIG. 44 is a flow chart showing the procedures of the computer system in the cooking system of FIG. 42 during the cooking of a food.

### DETAILED DESCRIPTION OF THE INVENTION

For the present patent application, a rotational mechanism comprises two mating parts, and a connection configured to constrain the relative motion of the mating parts to a rotation around an axis; wherein the axis of the relative rotation is relatively fixed with respect to either mating part. The axis of the relative rotation is referred to as the axis of the rotational mechanism. The mating parts may or may not touch each other. In many applications, one of the two mating parts may be a shaft, and the other may be a bearing housing, and the connection may comprise one or more bearings and accessories. Any one of the mating parts may be rigidly or otherwise connected to some other member(s) in the cooking systems to be described below.

For the present patent application, a computer system is meant to be any system or apparatus that includes one or more computers. A computer system may or may not include a database. A computer system may or may not include a network. A computer system may or may not include a memory shared by more than one computers. A computer system may include software. A single computer with software can be considered to be a computer system.

Various parts of our cooking apparatuses and cooking systems are described below.

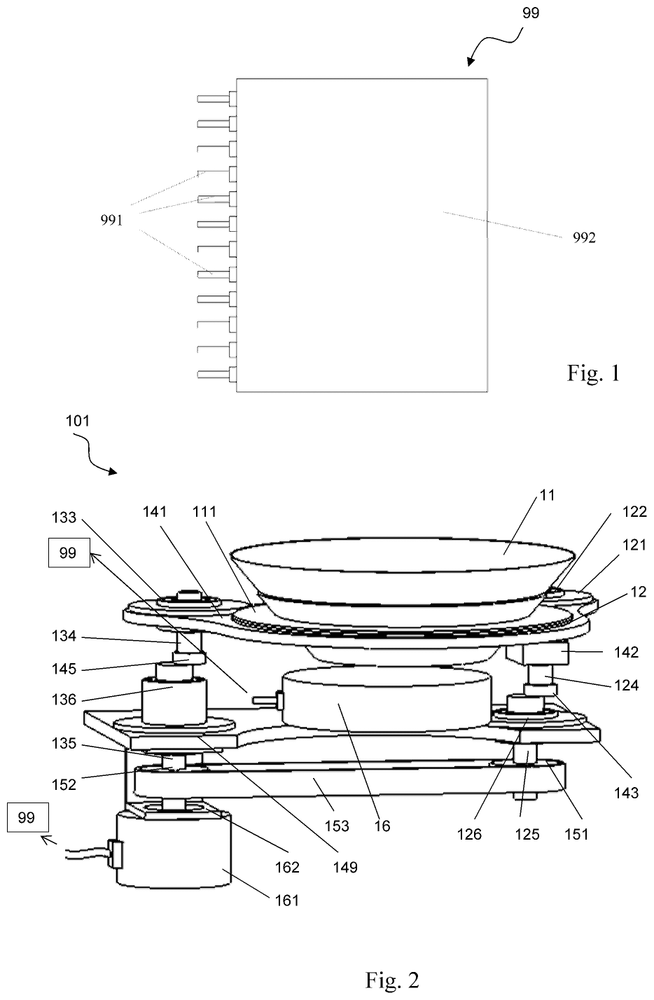

Referring to FIG. 1, a computer system 99 comprises a computer 992 with I/O ports 991. Via said I/O ports 991, said computer 992 may be connected to other electric or electronic parts including but not limited to: motors, inductive stoves, sensors, etc. The connection of the computer 992 to said electric or electronic parts may comprise wires, wireless communication devices, controllers, drivers, and/or circuit boards.

It should be noted that the computer system 99 may further comprise additional computers, a computer network, a database, computer programs, wireless communication ports, and/or other electric and electronic components.

A connection of said computer system 99 to an electric or electronic device may comprise a connection of a computer of said computer system to said device. Thus, a device is connected to said computer system 99 if said device is connected to a computer of said computer system.

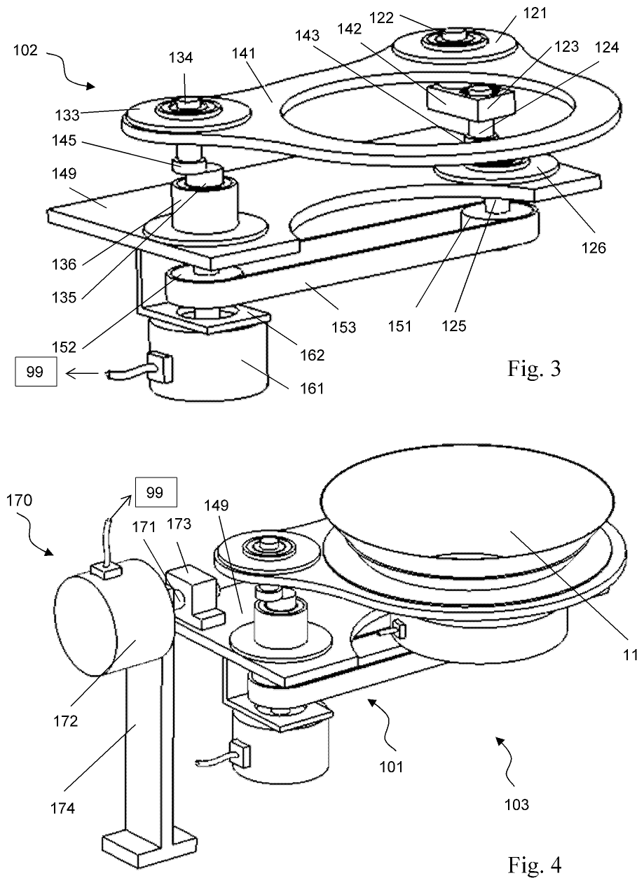

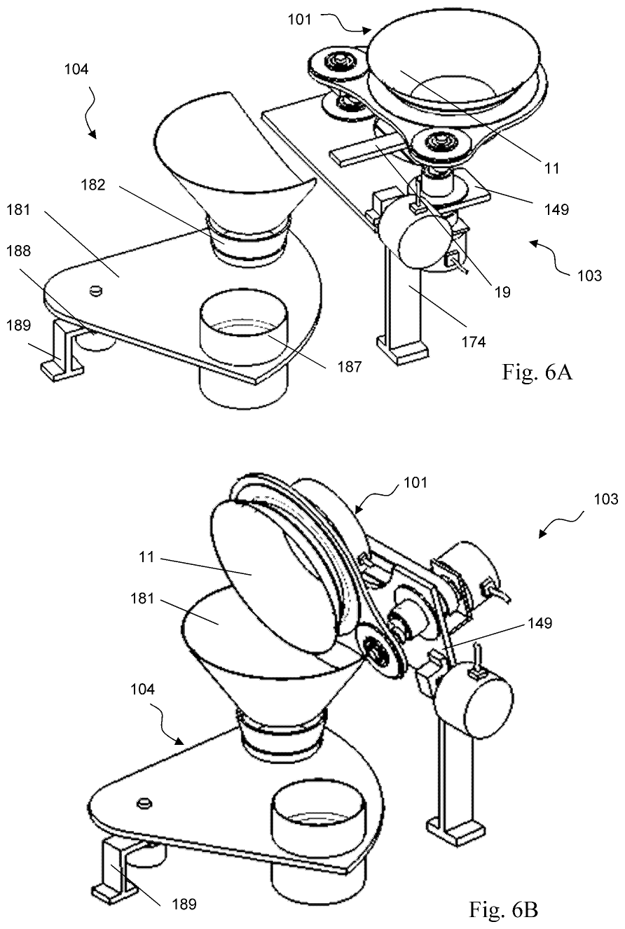

Referring to FIGS. 2-3, a cooking apparatus 101 comprises: a cookware 11; a heat insulation member 12; an inductive stove 16; and temperature sensors (not showing in the figures). The cookware 11 is configured to contain or otherwise hold food or food ingredients during a cooking process, when the cookware 11 is at or near an upright position. The cookware 11 comprises ferromagnetic metal (or other ferromagnetic material) at bottom. The heat insulation member 12 and temperature sensors are all fixedly connected to the cookware 11 via a connector 111. The temperature sensors may sense the temperature of some surfaces of the cookware. The temperature sensors are connected to the computer system 99 by wires so that the computer system 99 may be able to read or estimate the temperatures of the cookware 11. The inductive stove 16 is configured to heat the ferromagnetic metal in the cookware 11. The inductive stove 16 may be fixedly connected with the connector 141 (although the connection is not shown in figure). Alternatively, the inductive stove 16 may be fixedly connected to a rigid connector 149 via a connector 19. See FIG. 6A.

The cooking apparatus 101 further comprises a stirring mechanism 102, wherein stirring mechanism 102 comprises: a first rotational mechanism comprising mating parts 133 and 134; a second rotational mechanism comprising mating parts 135 and 136; a third rotational mechanism comprising mating parts 123 and 124; a fourth rotational mechanism comprising mating parts 125 and 126; a fifth rotational mechanism comprising mating parts 121 and 122. The axes of all these rotational mechanisms are parallel to each other, and the distance between the axis of the first rotational mechanism and the axis of the second rotational mechanism is equal to the distance between the third rotational mechanism and the fourth rotational mechanism. See FIG. 3.

The stirring mechanism 102 further comprises rigid connectors 141, 142, 143, 145 and 149. The connector 141 rigidly connects the parts 133 and 121. The connector 142 rigidly connects the parts 122 and 123. The connector 143 rigidly connects the parts 124 and 125. The connector 145 rigidly connects the parts 134 and 135. The connector 149 rigidly connects the parts 136 and 126.

The stirring mechanism 102 further comprises pulleys 151 and 152, and a timing belt 153. The pulley 151 is fixedly connected to the part 125 and the axis of the pulley 151 is the same as the axis of the fourth rotational mechanism, which comprises the mating parts 125 and 126. The pulley 152 is fixedly connected to the part 135, and the axis of the pulley 152 is the same as the axis of the second rotational mechanism, which comprises the mating parts 135 and 136. The pulleys 151 and 152 are coplanar, and to have the same radii. The timing belt 153 connects the pulleys 151 and 152 so that the pulleys 151 and 152 are constrained to rotate synchronously. Moreover, the plane containing the axes of the first rotational mechanism and the axis of the second rotation mechanism is parallel to the plane containing the axis of the third rotational mechanism and the axis of the fourth rotational mechanism. Thus, the parts 124 and 134 are rotated synchronously.

The stirring mechanism 102 further comprises: a motorized mechanism 161 configured to produce a rotation in the mating part 135 relative to the mating part 136 in the second rotational mechanism. A base component of the motorized mechanism 161 is fixedly connected to the rigid connector 149 by a connector 162. The motorized mechanism 161 is connected to the computer system 99 via wires, so that the computer system 99 may control the timing and speed of the motorized mechanism.

The rigid connector 149 may be referred to as the support component of the stirring mechanism 102. When the motorized mechanism 161 produces a rotation in the part 135 relative to the part 136 (or equivalently, relative to the support component 149), the rigid connector 141 (and the parts 133 and 121) makes a circular motion without self-rotation. Each point of the rigid connector 141 (or of the parts 133 or 121) is rotated in a circular motion relative to the support component 149, and the trajectory of the point is a circle whose radius is equal to the eccentricity of the stirring mechanism, wherein the circle lies on a plane which is perpendicular to the axes of the rotational mechanisms.

It should be noted that a connection of the part 123 with the rigid connector 141 comprises the fifth rotational mechanism (comprising mating parts 121 and 122) and the connector 142. This connection may be substituted by a rigid connection. The presence of the fifth rotational mechanism in the connection is for the purpose of easing tensions and strains in the stirring mechanism when the rotations in the parts 125 and 135 are not perfectly synchronous due to manufacturing or assembly errors.

It should be noted that the motorized mechanism 161 may comprise a motor comprising a shaft and a base component, a fixed connection of the shaft of the motor with the part 135, wherein the axis of the shaft of the motor is the same as the axis of the second rotational mechanism. The connector 162 may be a fixed connection of the base component of the motor and the support component 149.

The distance between the axis of the first rotational mechanism and the axis of the second rotational mechanism is referred to as the eccentricity of stirring mechanism 102.

It should be noted that the parts 122, 124, 125, 134 and 135 may be shafts, and the parts 121, 123, 126, 133 and 136 may be bearing housings.

In the cooking apparatus 101, the cookware 11 may be substituted by any cookware configured to contain or otherwise hold food or food ingredients when it is at or near an upright position.

In some embodiments, referring to FIG. 4, a cooking apparatus 103 comprises a cooking apparatus 101 and unloading mechanism 170, which comprises: a shaft 171, a motorized mechanism 172, rigid connectors 173 and 174. The shaft 171 comprises a horizontal axis. The connector 173 rigidly connects the shaft 171 and the component 149. The motorized mechanism 172 comprises a base component which is rigidly connected to the ground by the rigid connector 174. The motorized mechanism 172 is connected to the shaft 171 and is configured to produce a back-and-forth motion between two end-positions in the shaft 171 around the axis of the shaft 171.

Since the shaft 171 of the unloading mechanism 170 is rigidly connected to the support component 149 of the stirring mechanism 102, the motorized mechanism 172 of the unloading mechanism 170 may produce a back-and-forth rotation in the support component 149. At a first end-position of the support component 149 in the back-and-forth rotation, the axis of the first rotational mechanism (comprising mating parts 133 and 134) is vertical, and the cookware 11 is at the upright position. At the second end-position of the support component 149 in the back-and-forth rotation, the cookware 11 is turned at an angle as to dispense a cooked food held in the cookware 11. The angular degree between the first end-position and the second end-position is usually between 90 degrees and 180 degrees.

It should be noted that said unloading mechanism 170 may be substituted by a motion mechanism configured to move the cookware 11 directly.

It should be noted that the cooking apparatus 103 comprises: the stirring mechanism 102 configured to produce a motion in the cookware 11 as to stir or mix food or food ingredients contained or otherwise held in the cookware 11; and an unloading mechanism 170 comprising the motorized mechanism 172, the shaft 171 and the connectors 173 and 174, said unloading mechanism 170 is configured to produce a motion in the stirring mechanism 102 and the cookware 11 as to dispense a cooked food from the cookware 11.

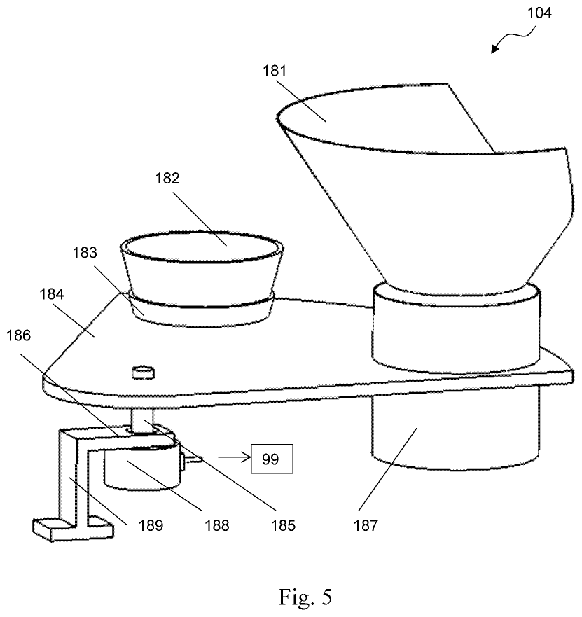

Referring to FIG. 5, a receiving mechanism 104 comprises: a funnel 181; a holder 183; a rotational mechanism comprising mating parts 185 and 186, wherein the part 185 is a shaft and the axis of the rotational mechanism is the axis of the shaft 185; rigid connectors 184 and 189; a motorized mechanism 188. The funnel 181 may be fixedly connected to the ground (although the connection is not shown in figures). A food container 182 may be positioned on the holder 183 and is configured to contain or otherwise hold a cooked food. The motorized mechanism 188 comprises a base component which is connected to the ground by the rigid connector 189. The motorized mechanism 188 is configured to produce a back-and-forth rotation in the shaft 185 around the axis of the shaft 185. The axis of the shaft 185 is vertical, and the holder 183 and the food container 182 may be rotated around the (vertical) axis of the shaft 185. The rigid connector 184 rigidly connects the holder 183, a waste-water pipe 187 and the shaft 185. Thus, the motorized mechanism 188 produces a back-and-forth rotation in the holder 183 and the waste-water pipe 187 between two end-positions. Since a rotation around a vertical axis is always a planar motion, a food container 182 placed on the holder 183 and the waste-water pipe 187 may be moved in a planar motion, as the holder 183 is moved. At a first end-position of the holder 183 in the back-and-forth motion, the food container 182 on the holder 183 is positioned right below the funnel 181 as to receive a cooked food which is dispensed into the funnel from above. At a second end-position of the holder 183 in the back-and-forth motion, the waste-water pipe 187 is positioned right below the funnel 181 so that the wastewater which is dispensed into the funnel may flow from the waste-water pipe 187 to a drainpipe.

Referring to FIGS. 6A-6B, when the support component 149 of the cooking apparatus 101 in the cooking apparatus 103 is moved to the second end-position from the first end-position, a cooked food held in the cookware 11 may be dispensed into the funnel 181, and dispensed into a food container 182 which is on the holder 183 (see FIG. 6B). Prior to this motion, the holder 183 held in the receiving mechanism 104 is moved to the first end-position. When the support component 149 of the cooking apparatus 101 in the cooking apparatus 103 is moved to the second end-position from the first end-position, the wastewater held in the cookware 11 may be dispensed into the funnel 181, and flow through the wastewater pipe 187. Prior to this motion, the waste-water pipe 187 in the receiving mechanism 104 is moved to the second end-position.

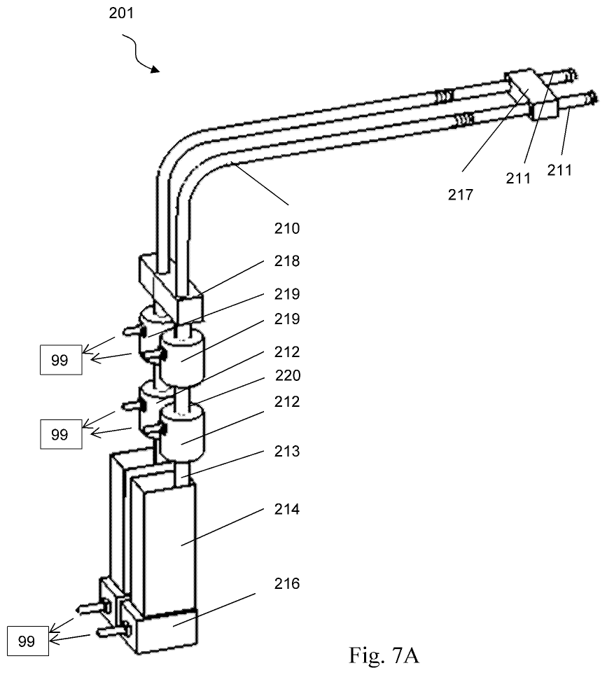

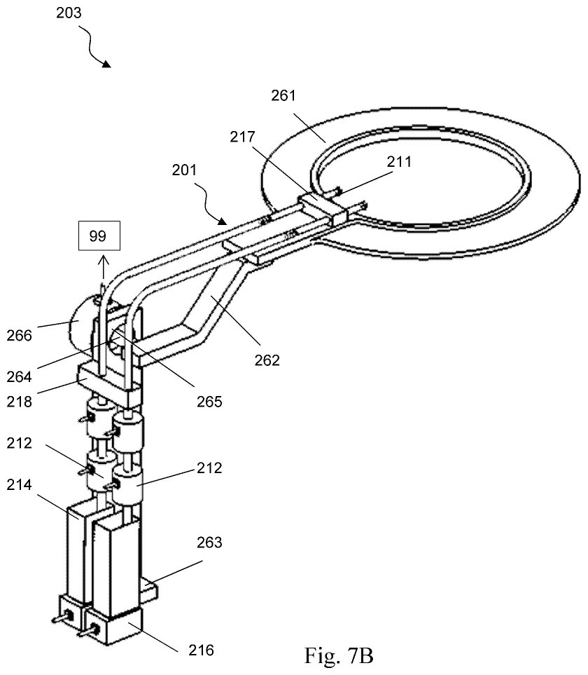

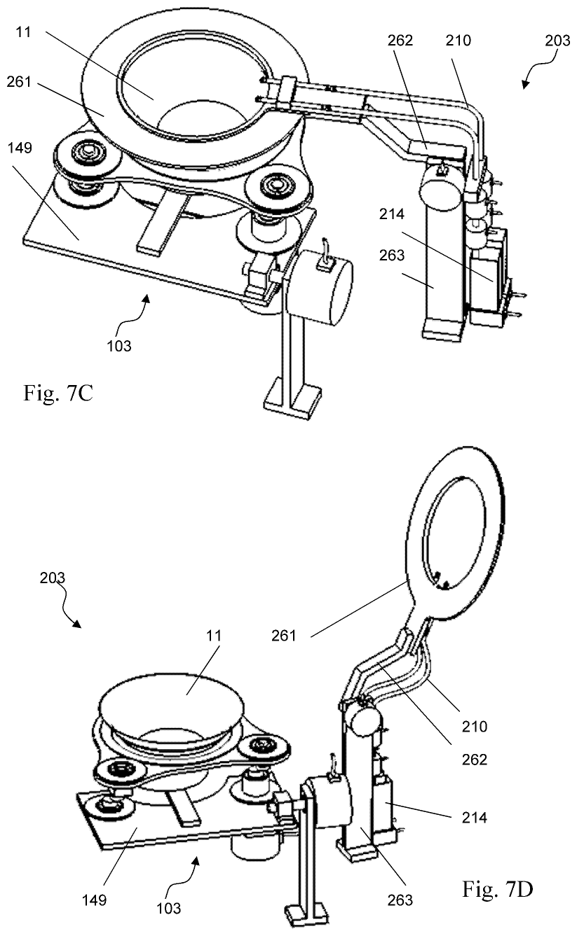

Referring to FIG. 7A, a liquid dispensing mechanism 201 comprises: a plurality of liquid pipes 211; a plurality of flexible pipes 210; a plurality of flowmeters 219; a plurality of liquid pipes 220; a plurality of liquid pipes 213; a plurality of liquid pumps 212; a plurality of electronic balance 216; a plurality of liquid containers 214; connectors 217 and 218. Each liquid container 214 is configured to hold a liquid, e.g., cooking oil, vinegar, or water. Each liquid pipe 211 is connected to a flexible pipe 210 via a connector. Each flowmeter 219 is connected to a pair of corresponding pipes 220 and 210. Each pump 212 is connected to a pair of corresponding pipes 220 and 213; and said pipe 213 is inserted into a corresponding liquid container 214, so that the pump can draw liquid from the liquid container and the flowmeter can measure the flow of the corresponding pipes. Each container 214 is positioned on an electronic balance 216, so that the electronic balance 216 can weigh the corresponding container 214. Each electronic balance is connected to the ground by a connector. Each pump 212, each flowmeter 219 and each electronic balance 216 is connected to the computer system 99, so that the computer system may control the timing and amount of liquid to be drawn from the corresponding liquid container. The connector 217 fixedly connects the pipes 211 to improve rigidity or stability of the pipes.

Referring to FIG. 7B, a lid apparatus 203 comprises: a blocking device 261; a shaft 264; a motorized mechanism 266; support components 262 and 263. The support component 262 rigidly connects the shaft 264 and the blocking device 261. The motorized mechanism 266 comprises a base component which is rigidly connected to the ground by the support component 263. The motorized mechanism 266 is configured to produce a back-and-forth motion between two end-positions in the shaft 264 around the axis of the shaft 264. The axis of the shaft 264 is horizontal. Since the shaft 264 is rigidly connected to the support component 262, the motorized mechanism 266 produces a back-and-forth rotation in the support component 262 and the blocking device 261 between two end-positions (relative to the ground). The motorized mechanism 266 is connected to the computer system 99 via wires, so that the computer system 99 may control the timing and speed of the motorized mechanism 266.

The lid apparatus 203 further comprises the liquid dispensing mechanism 201; wherein the connector 217 of the liquid dispensing mechanism 201 is rigidly connected to the blocking device 261; wherein the connector 218 of the liquid dispensing mechanism 201 is rigidly connected to the support component 263.

Referring to FIGS. 7C-7D shows the relative positions of the above lid apparatus 203 and the cookware 11 of a cooking apparatus 103. At a first end-position of the support component 262 (in the back-and-forth rotation produced by the motorized mechanism 266), and the open end of the pipes 211 is to be positioned above the cookware 11 when the cookware 11 is at the upright position (see FIG. 7C), so that the liquid may be flown into the cookware 11. The liquid dispensing mechanism 201 of the lid apparatus 203 is used to dispense a plurality of liquid ingredients into the cookware 11 of a cooking apparatus 103 when the support component 262 is at the first end-position and the cookware 11 is at the upright position.

When the support component 262 is rotated to the second end-position, the components 261, 217 and 211 are all rotated by an angle, away from the cookware 11. The angular degree between the first end-position and the second end-position may be about 90 degrees, although this is not a strict requirement.

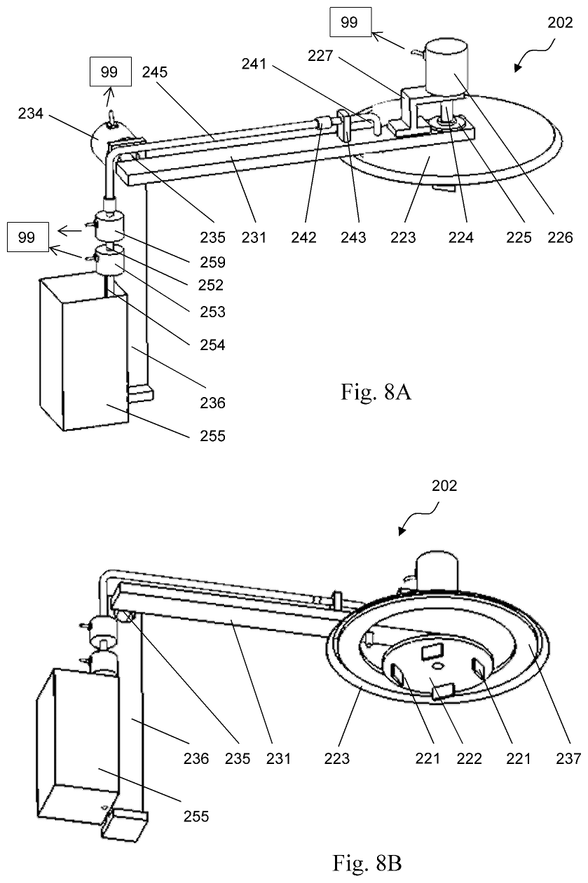

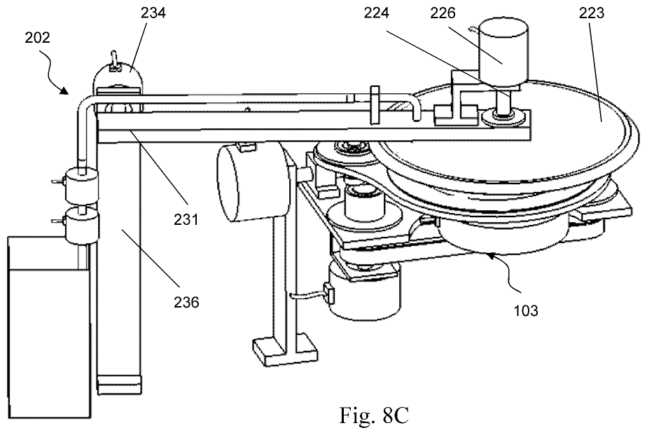

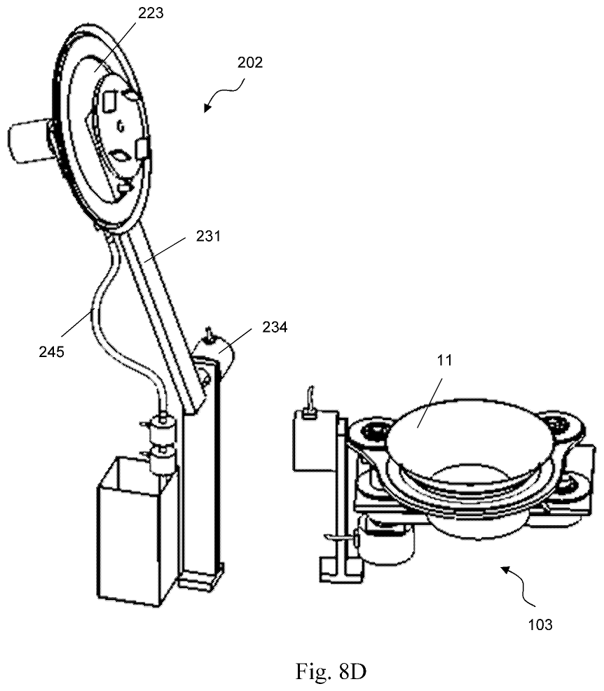

Referring to FIGS. 8A-8B, a cookware cleaning mechanism 202 comprises: a plurality of blades 221; a board 222; a cover 223; a seal 237; a rotational mechanism comprising mating parts 224 and 225, wherein the part 224 is a shaft and the axis of the rotational mechanism is the axis of the shaft; and a motorized mechanism 226. The motorized mechanism 226 is configured to produce rotation in the shaft 224 around the axis of the shaft 224. The board 222 rigidly connects the blades 221 and the shaft 224. Thus, the motorized mechanism 226 produces a rotation in blades 221 around the axis of the shaft 224. The seal 237 in the shape of a ring is attached on the cover 223, wherein the axis of the seal 237 is concentric with the cover 223. The motorized mechanism 226 is connected to the computer system 99 via wires, so that the computer system 99 may control the timing and speed of the motorized mechanism 226.

The cookware cleaning mechanism 202 further comprises: a support component 231; a shaft 235; a motorized mechanism 234; a rigid connector 236. The shaft 235 comprises a horizontal axis. The support component 231 rigidly connects the shaft 235 and the mating part 225. The motorized mechanism 234 comprises a base component which is rigidly connected to the ground by the rigid connector 236. The motorized mechanism 234 is configured to produce a back-and-forth motion between two end-positions in the shaft 235 around the axis of the shaft 235. The axis of the shaft 235 is horizontal, and perpendicular to the axis of the shaft 224. Since the shaft 235 is rigidly connected to the support component 231, the motorized mechanism 234 produces a back-and-forth rotation in the support component 231 between two end-positions (relative to the ground). The motorized mechanism 234 is connected to the computer system 99 via wires, so that the computer system 99 may control the timing and speed of the motorized mechanism 234.

The motorized mechanism 226 comprises a base component which is fixedly connected to the support component 231 by a rigid connector 227. The cover 223 is fixedly connected to the support component 231. The blades 221 and the board 222 are both configured to be rotationally symmetric around the axis of the shaft 224.

The cookware cleaning mechanism 202 further comprises: (inflexible) pipes 241, 252 and 254; a flexible pipe 245; pipe connectors 242; a connector 243; a liquid pump 253; a flowmeter 259; a liquid source 255. The pipe 241 is connected to the pipe 245 by the pipe connector 242; and the other end of the pipe 241 is open. The flowmeter 259 is connected to the pipes 245 and 252. The liquid pump 253 is connected to the pipes 252 and 254. The pipe 254 is connected to a liquid source 255. The connector 243 fixedly connects the support component 231 and the pipe 241. The liquid pump 253 is configured to draw liquid from the liquid source 255 and flow liquid from the liquid source to the open end of the pipe 241. The flowmeter 259, the liquid source 255, and a base component of the liquid pump 253 are fixedly connected the ground. The liquid pump 253 is connected to the computer system 99, so that the computer system may control the timing and amount of liquid to be drawn from the liquid source.

Referring to FIGS. 8C-8D shows the relative positions of the above cookware cleaning mechanism 202 and the cookware 11 of a cooking apparatus 103. At a first end-position of the support component 231 (in the back-and-forth rotation produced by the motorized mechanism 234), the axis of the rotational mechanism (which comprises the mating parts 224 and 225) is vertical and the open end of the pipe 241 is to be positioned above the cookware 11 when the cookware 11 is at the upright position (see FIG. 8C), so that liquid may be flown into the cookware 11. The liquid may be used to clean the cookware 11.

The motorized mechanism 226 is configured to drive a one-way rotation of the blade 221 to wash the inner surface of the cookware, while the cover 223 seals the cookware. Liquid may be partially trapped by the board 222, while the rotating blades may pressure the liquid to flow towards the axis of the shaft 224, hence toward the center of the cookware, thus build a pressure in the liquid therein.

When the support component 231 is rotated to the second end-position, the components 221, 222, 223, 224, 225, 226 and 227 are all rotated by an angle, away from the cookware. The angular degree between the first end-position and the second end-position may be about 90 degrees, although this is not a strict requirement.

The liquid in the liquid source 255 may comprise hot water or other liquid suitable for cleaning a cookware.

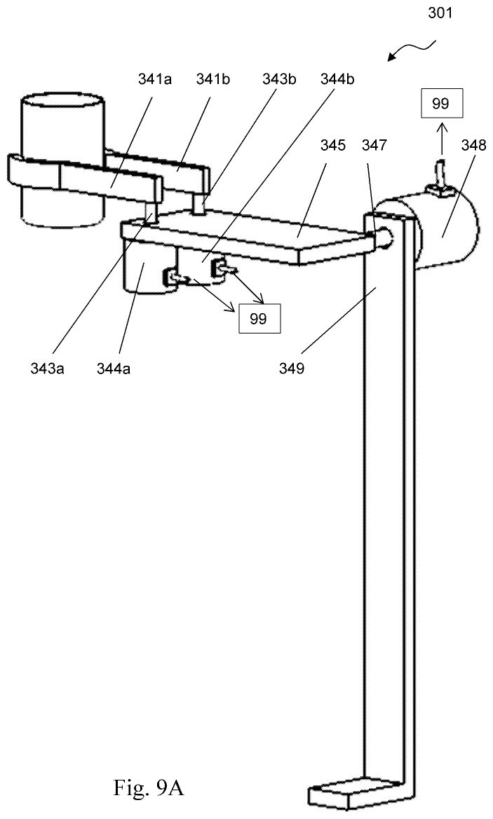

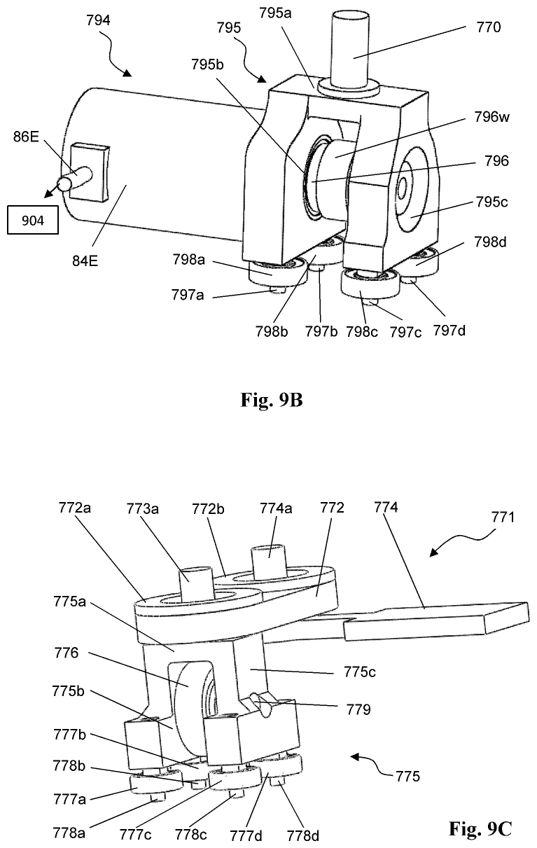

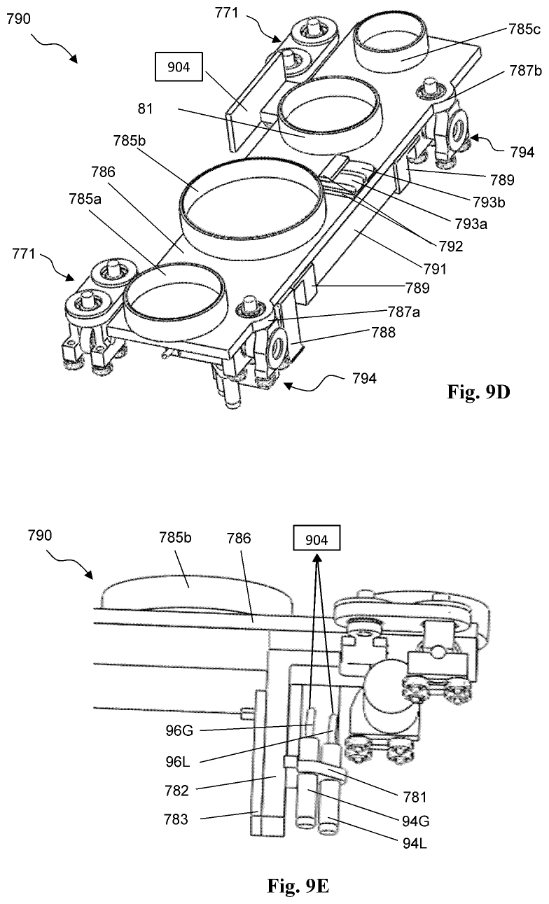

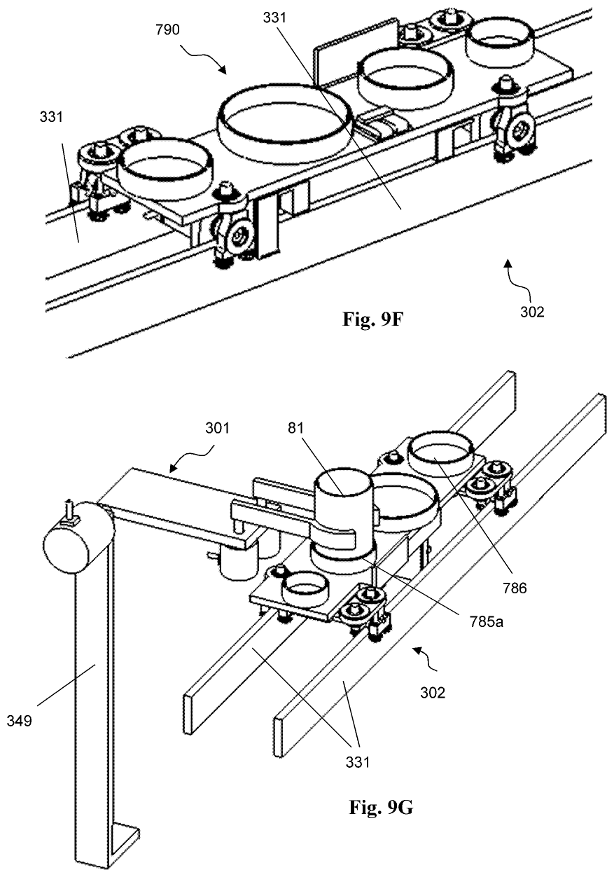

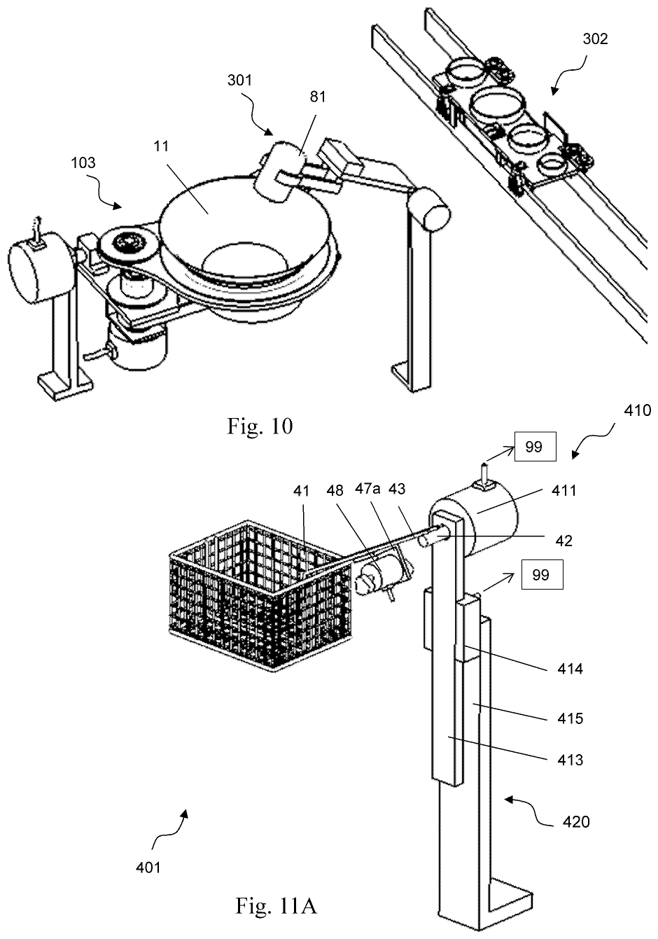

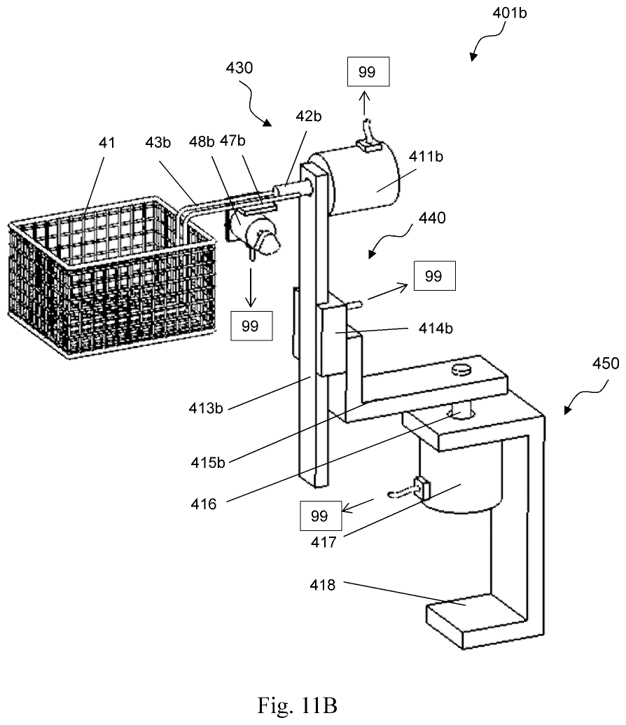

Referring to FIG. 9A, a dispensing mechanism 301 comprises: a support component 345; gripping devices 341a and 341b; shafts 343a and 343b; motorized mechanisms 344a and 344b. The motorized mechanism 344a or 344b comprises a base component which is rigidly connected to the support component 345. The gripping device 341a is rigidly connected to the shaft 343a. The motorized mechanism 344a is configured to produce a rotation in the shaft 343a around the axis of the shaft 343a relative to the support component 345. Similarly, the gripping device 341b is rigidly connected to the shaft 343b. The motorized mechanism 344b is configured to produce a rotation in the shaft 343b around the axis of the shaft 343b relative to the support component 345. As the gripping device 341a or 341b is rigidly connected to the shaft 343a or respectively 343b, the motorized mechanism 344a or 344b produces a rotation in the gripping device 341a or respectively 341b. The shafts 343a and 343b have parallel axes, and the motorized mechanisms 344a and 344b are configured to rotate the respective gripping devices 341a and 341b in opposite directions simultaneously. In fact, the gripping devices 341a and 341b may be configured to rotate anti-synchronously. The gripping device 341a or 341b is rotated between two end-positions. At some first end-positions, the gripping devices 341a and 341b are configured to work together to grip a container under the condition that the container is placed in a certain position relative to the support component 345.

The ingredient dispensing mechanism 301 further comprises: a shaft 347; a motorized mechanism 348; a rigid connector 349. The shaft 347 comprises a horizontal axis; and said axis is perpendicular to the axes of the shafts 343a and 343b. The support component 345 is rigidly connected to the shaft 347. The motorized mechanism 348 comprises a base component which is rigidly connected to the ground by the rigid connector 349. The motorized mechanism 348 is configured to produce a back-and-forth motion, between two end-positions, in the shaft 347 around the axis of the shaft 347. The rigid connector 349 is referred to as the support component of the ingredient dispensing mechanism 301.

Since the shaft 347 is rigidly connected to the support component 345, the motorized mechanism 348 produces a back-and-forth rotation in the support component 345 between two end-positions. At a first end-position of the support component 345 in the back-and-forth rotation, the axes of the shaft 343a and 343b are vertical and the gripping devices 341a and 341b, when rotated to their first end-positions relative to the support component 345, are configured to grip a container, in an upright position, which contains food or food ingredients, under the condition that the container is at a certain position relative to the support component 349. Said position of the container is referred to as the dispensing position relative to the support component 349. Then, the support component 345 is rotated to the second end-position while the container is gripped by the gripping devices 341a and 341b, so that the container is turned by an angle as to dispense the food or food ingredients into a cookware or a basket. Virtually entire contents of the container are dispensed by the turning of the container. The angular degree between the first end-position and the second end-position in the rotation of the support component 345 is usually between 90 degrees and 180 degrees. The motorized mechanisms 344a, 344b and 348 are connected to the computer system 99 via wires, so that the computer system 99 may control the timing and speed of the motorized mechanisms.

Referring to FIGS. 9B-9E, a vehicle 790 comprises: a support component 786 comprising two bearing housings 787a and 787b as parts; a computer 904 which is fixedly connected to the support component 786 by connectors; a target 788 which is rigidly connected to the support component 786; two driving wheel mechanisms 794; two universal wheel mechanisms 771. The bearing housing 787a or 787b is connected to the shaft 770 of one of the driving wheel mechanisms 794 by bearings and accessories, so that the shaft 770 is constrained to rotate relative to the support component 786 around the axis of the shaft 770. The connecting components 774 of the universal wheel mechanisms 771 are rigidly connected to the support component 786.

The computer 904 comprises a plurality of input ports and a plurality of output ports. The input ports of the computer 904 may be connected (either via wires or via wireless communication devices) to sensors, which can be encoders, pressure sensors, proximity switches, micro switches, infrared sensors, temperature sensors, etc. The output ports of the computer 904 may be connected to electrical or electronic devices which can be several types of motors, stoves, refrigeration apparatus, etc. The signals of the sensors may be sent to the computer 904. The computer 904 may control the operations of the electrical or electronic devices by sending signals to the electrical or electronic device. The computer 904 is configured to communicate with the computer system 99 via wireless communication devices.

Referring to FIG. 9B, a driving wheel mechanism 794 comprises: a support component 795; a shaft 796 comprising a horizontal axis, and a wheel 796w which is rigidly connected to and concentric with the shaft 796; shafts 770, 797a, 797b, 797c and 797d, each comprising a vertical axis; and wheels 798a, 798b, 798c and 798d. The support component 795 comprises a pair of bearing housings 795b and 795c which have a same horizontal axis. The shaft 770 is rigidly connected to a top part 795a of the support component 795. The shaft 796 is connected to the bearing housings 795b and 795c by bearings and accessories, so that the shaft 796 is constrained to rotate relative to the support component 795 around the axis of the shaft 796. The shafts 797a, 797b,797c and 797d are rigidly connected to (some bottom parts of) the support component 795. The wheels 798a, 798b, 798c and 798d are respectively mounted on the shafts 797a, 797b, 797c and 797d, so that each wheel is constrained to rotate relative to the support component 795 around the axis of the respective shaft.

The driving wheel mechanism 794 further comprises a motor 84E comprising a shaft and a base component. The base component of the motor 84E is fixedly connected to the bearing housing 795b. The shaft of the motor 84E is fixedly connected to the shaft 796, so that the motor 84E can drive a rotation in the shaft 796 and hence in the wheel 796w relative to the support component 795 around the axis of the shaft 796. As shown in FIG. 9B, the motor 84E is connected to a computer 904 via wires 86E and the computer 904 is configured to send signals to the motor 84E as to control the timing and the degree of rotation of the motor 84E.

Referring to FIG. 9C, a universal wheel mechanism 771 comprises: a support component 775; a connector 772 comprising two bearing housings 772a and 772b as parts; a connecting component 774 comprising a vertical shaft 774a; a shaft 779 comprising a horizontal axis; shafts 773a, 778a, 778b, 778c and 778d, each comprising a vertical axis; and wheels 776, 777a, 777b, 777c and 777d. The shaft 773a is rigidly connected to a top part 775a of the support component 775. The shaft 773a is connected to the bearing housing 772a by bearings and accessories, so that the support component 775 and the shaft 773a are constrained to rotate relative to the bearing housing 772a (or equivalently, relative to the connector 772) around the axis of the shaft 773a. The shaft 774a of the connecting component 774 is connected to the bearing housing 772b by bearings and accessories, so that the connecting component 774 is constrained to rotate relative to the bearing housing 772b (or equivalently, relative to the connector 772) around the axis of the shaft 774a. The shaft 779 is fixedly connected to the support component 775. The wheel 776 is mounted on the shaft 779, so that the wheel 776 is constrained to rotate relative to the shaft 779 (and hence relative to the support component 775) around the axis of the shaft 779. The shafts 778a, 778b,778c and 778d are rigidly connected to (some bottom parts of) the support component 775. The wheels 777a, 777b, 777c and 777d are respectively mounted on the shafts 797a, 797b, 797c and 797d, so that each wheel is constrained to rotate relative to the support component 775 around the axis of the respective shaft.

The vehicle 790 further comprises: a plurality of round container holders 785a, 785b and 785c wherein each container holder 785a, 785b or 785c comprises a vertical axis; a rechargeable battery 791 configured to power electrical or electronic devices on the vehicles; a plurality of mounting devices 789 configured to fixedly connect the rechargeable battery 791 to the support component 786; an insulation component 792 made of plastic or other electric insulating material; and a pair of electrical inlets 793a and 793b connected to the rechargeable battery 791 by wires. The electrical inlets 793a and 793b and the insulation component 792 are all fixedly connected to the support component 786. The container holders 785a, 785b and 785c are fixedly connected to the support component 786. Each container holder, 785a, 785b, or 785c, is configured to hold an ingredient container 81 of a specific diametrical size.

The container holders 785a, 785b and 785c are also referred to as holders. It should be noted that the container holders 785a, 785b and 785c in the vehicle 790 may be substituted by other types of container holders.

The vehicle 790 further comprises: an L-shaped support component 782 comprising a vertical board and horizontal board; a magnet 783 configured to fixedly mounted on the vertical board of the L-shaped support component 782; a connector 781 configured to fixedly connected to the vertical board of the L-shaped support component 782; and two proximity switches 94L and 94G connected to the connector 781 (see FIG. 9E). The horizontal board of the L-shaped support component 782 is rigidly connected to the support component 786. The proximity switches 94L and 94G are connected to the computer 904 via wires 96L and 96G, so that the computer 904 may receive signals from the proximity switches 94L and 94G.

Each container holder 785a on a vehicle 790 may hold an ingredient container 81 so that the movement of said ingredient container may be restricted or limited when the vehicle is moving. Similarly, each container holder 785b on each vehicle 790 is configured to hold an ingredient container 81b wherein said ingredient container 81b is similarly configured as an ingredient container 81 except the size.

The vehicle 790 may comprise an electromagnet controlled by the computer 904. The computer 904 is configured to monitor the rechargeable battery 791. If the rechargeable battery is running low, the computer 904 is configured to turn on the electromagnet; otherwise the computer turns off the electromagnet. The electro-magnetic signal may be sensed by a sensor mounted next to a rail track, wherein said senor is connected to the computer system 99. The computer system can then automatically control the motion of the vehicle 790 so the vehicle can arrive at a charging station, so that the rechargeable battery gets charged.

It should be noted that the vehicle 790 may move on a pair of curved rail tracks whose widths are smaller than the widths of straight rail tracks.

Referring to FIG. 9F, a transport system 302 comprises a track comprising pairs of mini rails 331 and a plurality of vehicles 790. Each mini rail 331 of the transport system 302 is rigidly connected to the ground by a rigid connector. The vehicle 790 and the container holders 785a on the vehicle 790 may move along the mini rails 331. The transport system 302 is configured to transfer ingredient containers. The computer 904 is connected to the computer system 99 via wireless means, so that the computer system 99 may control the timing and speed of the vehicles 790.

It should be noted that the vehicle may comprise other components for the purpose of staying on track.

Referring to FIG. 9G, a vehicle 790 in the transport system 302 may move an ingredient container 81, in the upright position, to a dispensing position relative to the support component 349 of the ingredient dispensing mechanism 301. Then the support component 345 may be rotated to the first end-position relative to the support component 349 while the gripping devices 341a and 341b are kept at their second end-positions, and then, the gripping devices 341a and 341b are rotated to their first end-position as to grip the ingredient container 81.

FIG. 10 shows the relative position of the cooking apparatus 103, the ingredient dispensing mechanism 301 and the transport system 302. A vehicle 790 of the transport system 302 moves an ingredient container 81, which contains food ingredients, to a dispensing position relative to the support component 349 of the ingredient dispensing mechanism 301. The support component 345 of the ingredient dispensing mechanism 301 may be rotated to the first end-position, and then the gripping devices 341a and 341b may be moved to their first end-positions as to grip the ingredient container 81. Then the support component 345 is rotated to the second end-position, as to dispense the food ingredients from the ingredient container 81 into the cookware 11 of the cooking apparatus 103. The ingredient dispensing mechanism 301 is configured so that virtually entire content held in the ingredient container 81 is dispensed into the cookware 11; wherein exception (to the “virtually entire content”) may be a very small quantity of ingredients which are undesirably stubbornly sticking to a surface of the ingredient container 81 and this small quantity of ingredients will be waste. Afterwards, the support component 345 is rotated back to the first end-position, and after that, the gripping devices 341a and 341b are rotated to their second end-positions, as to let loose the emptied container, as to be placed on the container holders 785a of the vehicle 790. It should be noted that the vehicle 790 is braked during the time of the above procedures.

Referring to FIG. 11A, a cooking apparatus 401 comprises: a basket 41; a vibration device 48; a rotational motion mechanism 410 and a vertical motion mechanism 420. The rotational motion mechanism 410 comprises: a shaft 42; a connector 43; a motorized mechanism 411; a sliding member 413. The vertical motion mechanism 420 comprises a motorized mechanism 414 and a support component 415. The basket 41 comprises a bottom and many holes at and/or near the bottom. The basket 41 is porous in the sense that a liquid, such as water or oil contained in the basket may leak out when the basket is positioned at an upright position and when the basket is held in the air; and the basket 41, at or near said upright position, is configured to contain or otherwise hold solid food or food ingredients, wherein said solid food or food ingredients should have reasonably big enough diameters in comparison with the holes at or near the bottom of the basket. The connector 43 of the rotational motion mechanism 410 fixedly connects the basket 41 and the shaft 42. The motorized mechanism 411 of the rotational motion mechanism 410 is configured to rotate the shaft 42 and the basket 41 relative to the sliding member 413, back-and-forth between two end-positions; wherein at the first end-position, the basket is in the upright position; wherein the degree of rotation between the two end-positions can be fixed, between 150 and 180 in many applications. The vibration device 48 is connected to the connector 43 by a connector 47a. The vibration device 48 can produce a vibration in the connector 43 and the basket 41. A base component of the motorized mechanism 411 is rigidly connected to the sliding component 413. The support component 415 is fixedly connected to the ground. The motorized mechanism 414 of the vertical motion mechanism 420 produces an up-and-down motion in the sliding component 413 of the rotational motion mechanism 410 and the basket 41 between two end-positions. The motorized mechanisms 411 and 414 are both connected to the computer system 99, so that the computer system may control timings and speeds of their produced motions.

It should be noted that the sliding member 413 may be referred to as a support component of the rotational motion mechanism 410 and the support component 415 may be referred to as the support component of the cooking apparatus 401.

The basket 41 may comprise a metal net in some applications. The basket 41 may be an example of a porous cookware or porous container.

The basket 41 may be substituted by other type of porous container.

Referring to FIG. 11B, a cooking apparatus 401b is similarly constructed as the cooking apparatus 401 wherein the cooking apparatus 401b comprises: a basket 41; a vibration device 48b; a rotational motion mechanism 430; a vertical motion mechanism 440 and a rotational motion mechanism 450. The rotational motion mechanism 430 comprises: a shaft 42b comprising a horizontal axis; a connector 43b; a motorized mechanism 411b; a sliding member 413b. Said vertical motion mechanism 440 comprises a motorized mechanism 414b and a support component 415b. Said rotational motion mechanism 450 comprises: a shaft 416 comprising a vertical axis; a motorized mechanism 417; a support component 418. The basket 41, when in an upright position, is configured to contain or otherwise hold food or food ingredients. The basket 41 is porous. The connector 43b of rotational motion mechanism 430 fixedly connects the basket 41 and the shaft 42b. A base component of the motorized mechanism 411b is rigidly connected to the sliding component 413b. The motorized mechanism 411b of rotational motion mechanism 430 is configured to rotate the shaft 42b and the basket 41, between two end-positions around the axis of the shaft 42b relative to the sliding component 413b. At the first end-position, the basket is in the upright position. The vibration device 48b is connected to the connector 43b via a connector 47b. The vibration device 48b is configured to produce a vibration in the connector 47b and the basket 41. The motorized mechanism 414b of the vertical motion mechanism 440 is configured to move the sliding member 413b of rotational motion mechanism 430 linearly in the vertical position relative to the support component 415b between two end-positions. At the first end-position, the basket 41 is in the lower position. The support component 415b of the vertical motion mechanism 440 is fixedly connected to the shaft 416 of rotational motion mechanism 450. The base of the motorized mechanism 417 is fixedly connected to the ground via the support component 418. The motorized mechanism 417 of rotational motion mechanism 450 is configured to rotate the shaft 416 and the support component 415b, between two end-positions around the axis of the shaft 416 relative to the support component 418. The angular degree between the first end-position and the second end-position is usually about 180 degrees, although this is not a strict requirement.

It should be noted that the sliding member 413b may be referred to as a support component of the rotational motion mechanism 430 and the support component 418 may be referred to as the support component of the cooking apparatus 401b.

The motorized mechanisms 411b, 414b and 417 are all connected to the computer system 99, so that the computer system may control timings and speeds of their produced motions.

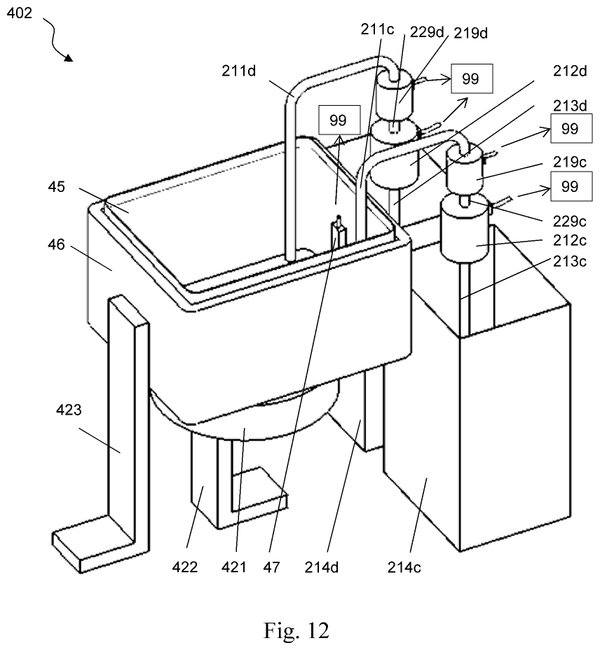

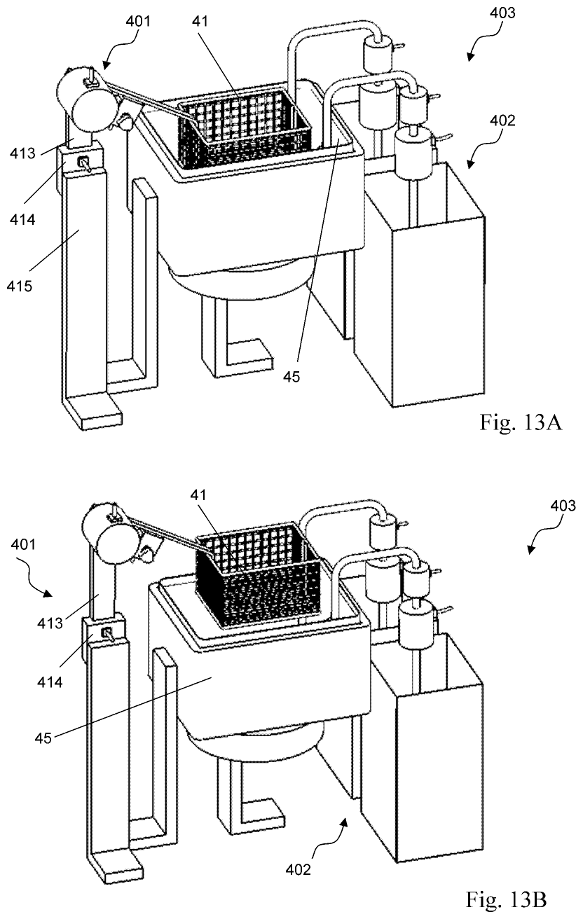

Referring to FIG. 12, a cooking apparatus 402 comprises: a liquid container 45; a heat insulation member 46; temperature sensors 47; inductive stove 421; a connector 423; and a connector 422. The heat insulation member 46 is mounted on the exterior of the liquid container 45. The connector 423 connects the insulation member (and hence the liquid container 45) to the ground. The connector 422 connects the inductive stove 421 to the ground. The inductive stove 421 is connected to the computer system 99. The temperature sensors 47 may sense the temperature of the liquid in the liquid container 45. The temperature sensors 47 are connected to the computer system 99. The liquid container 45 is configured to contain a cooking liquid, such as oil or water. The liquid container 45 comprises a ferromagnetic metal at a bottom part. The inductive stove 421 is configured to heat the ferromagnetic part of the liquid container 45, as to heat the liquid contained in the liquid container 45.

The cooking apparatus 402 further comprises: a pair of liquid pipes 211c and 211d; a pair of liquid pipes 229c and 229d; a pair of liquid pipes 213c and 213d; a pair of flowmeters 219c and 219d; a pair of liquid pumps 212c and 212d; a pair of liquid containers 214c and 214d. An end of the pipe 211c or 211d is inserted into the liquid contained in the liquid container 45 of the cooking apparatus 402. The liquid container 214c or 214d is configured to hold a liquid, e.g., cooking oil or water. The container 214c contains fresh liquid; and the container 214d contains waste liquid which will get disposed (disposed in sink if the waste liquid is wastewater). The temperature sensors 47 are mounted on the cookware. The pump 212c (or 212d) is connected to a pair of corresponding pipes 229c and 213c (or respectively 229d and 213d) and an end of said pipe 213c (or respectively, 213d) is inserted in the liquid contained in the liquid container 214c (or respectively, 214d). Each flowmeter 219c (or respectively, 219d) is connected to a pair of corresponding pipes 229c and 211c (or respectively, 229d and 211d) and said pipe 211c (or respectively, 211d) is inserted into the liquid container 45. The pump 212c is configured to draw fresh liquid from the liquid container 214c and pump it into the liquid container 45. The pump 212d is configured to draw (used) liquid from the liquid container 45 and pump it into the liquid container 214d. The flowmeter 219c and 219d can measure the liquid which pump into and from the liquid container 45. Pumps 212c, 212d and flowmeters 219c and 219d are connected to the computer system 99, so that the computer system may control the timing and amount of liquid to be drawn by the pump from the corresponding liquid container.

Referring to FIGS. 13A-13B, a cooking apparatus 403 comprises a cooking apparatus 401 and a cooking apparatus 402. When the basket 41 of the apparatus 401 is rotated to the first end-position relative to the sliding member 413, and the sliding member 413 is moved to the first end-position (i.e., the lower end-position) relative to the support component 415, the basket 41 is partially immersed in the liquid, as shown in FIG. 13B. When the basket 41 of the apparatus 401 is rotated to the first end-position relative to the sliding member 413, and when the sliding member 413 is moved to the second end-position (i.e., the upper end-position) relative to the support component 415, the basket 41 is lifted up from the liquid container 45. The basket 41 may be left at this position for another period of time, during which the vibration device 48 is configured to produce micro-vibrations in the basket 41 as to let the hot liquid attached to the basket 41 to drip into the liquid container 45, as shown in FIG. 13A. Then the motorized mechanism 411 may rotate the basket 41 as to dispense a cooked or semi-cooked food from the basket 41 (also see FIG. 16B later).

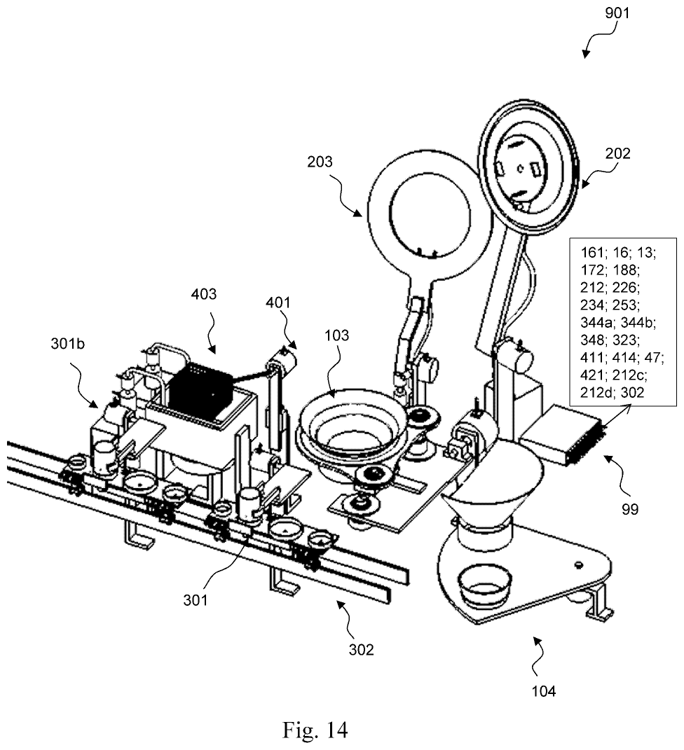

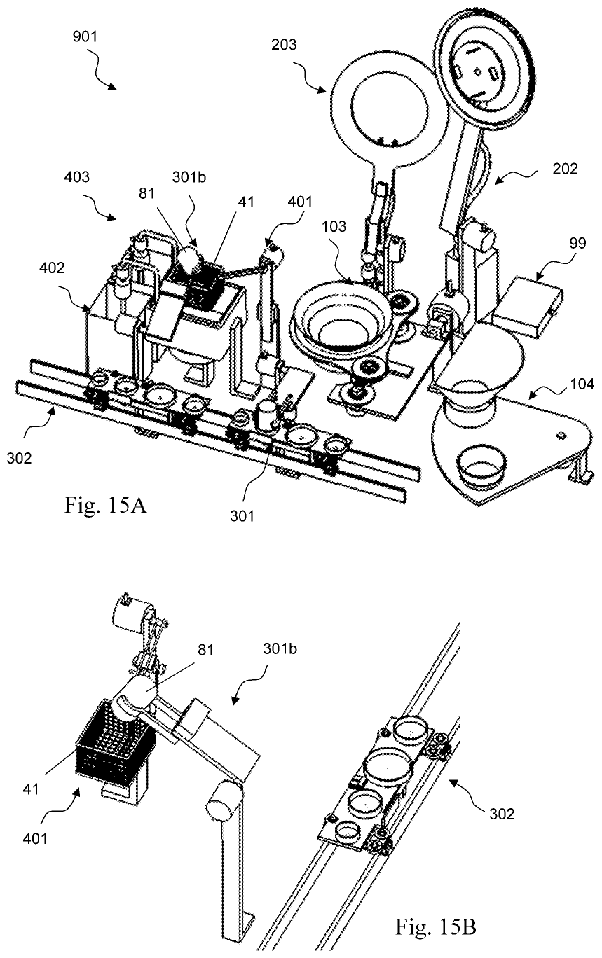

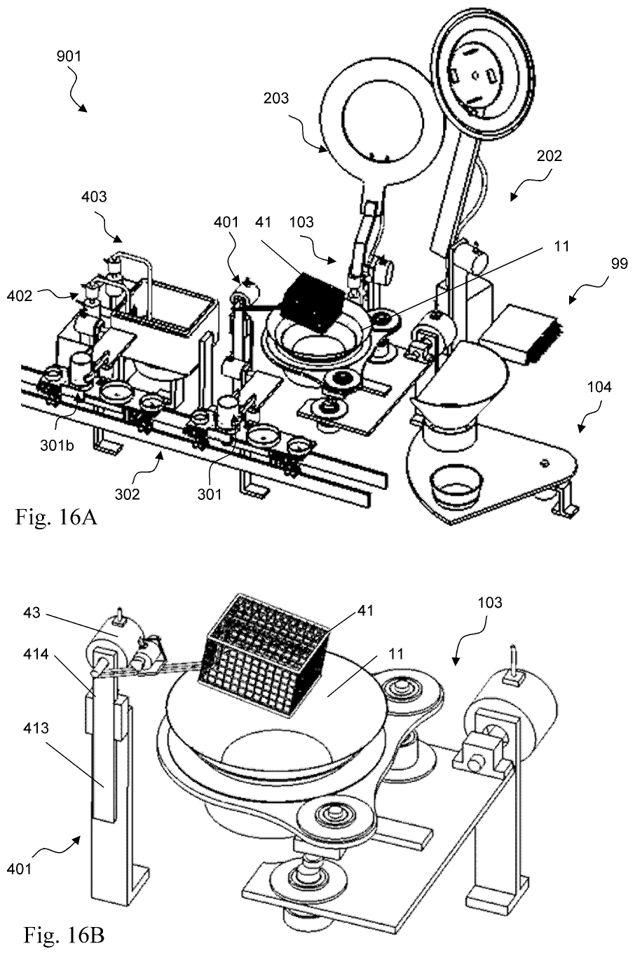

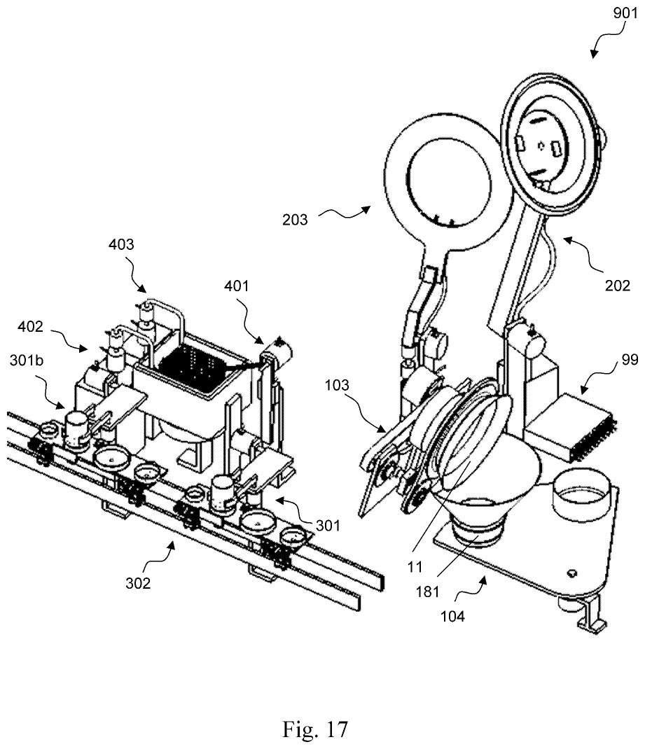

In some embodiments, referring to FIGS. 14-19, a cooking system 901 comprises (from left to right): a receiving apparatus 104; a cookware cleaning mechanism 202; a lid apparatus 203; a cooking apparatus 103; a first ingredient dispensing mechanism 301; a transport system 302; a cooking apparatus 403; a second ingredient dispensing mechanism 301b; and a computer system 99. The lid apparatus 203 is configured to dispense liquid ingredients into the cookware 11 (as shown in FIG. 7C). The first ingredient dispensing mechanism 301 is positioned next the cooking apparatus 103, as to dispense food ingredients into the cookware 11 of the cooking apparatus 103 (as shown in FIG. 10). The second ingredient dispensing mechanism 301b is a copy of the ingredient dispensing mechanism 301 with the same part numbers but is positioned next the cooking apparatus 403. The part numbers in the mechanism 301b are the same as the corresponding part numbers in the mechanism 301. As shown in FIGS. 15A-15B, the gripping devices of the ingredient dispensing mechanism 301b may be moved to grip an ingredient container 81 containing food ingredients and then rotate the container as to dispense the food ingredients from the container 81 into the basket 41 of the cooking apparatus 401. Meanwhile the basket 41 is at the first end-position relative to the sliding component 413; and the sliding component 413 is at the second end-position relative to the support component 415 (or equivalently, relative to the ground). Then, the sliding component 413 is moved down to the first end-position, so that the basket 41 holding the food ingredients may be immersed in a hot liquid in the liquid container 45 of the cooking apparatus 403. The food ingredients in the basket 41 are cooked in the hot liquid, as to produce a semi-cooked food. Then, the sliding component 413 is moved upward to the second end-position and the basket 41 is lifted and away from the hot liquid in the liquid container 45. The basket 41 may be left at this position for another period of time, during which the vibration device 48 is configured to produce micro-vibrations in the basket 41 as to let the hot liquid attached to the basket 41 and the semi-cooked food to drip into the liquid container 45. Then, as shown in FIGS. 16A-16B, the semi-cooked food contained in the basket 41 may be dispensed into the cookware 11 when the basket 41 is rotated from the first end-position to the second end-position relative to the sliding component 413 which stays at the second end-position. Then the semi-cooked food is further cooked by the cooking apparatus 103, possibly together with other ingredients, some of which are dispensed from an ingredient container on a holder of the transport system 302 by the first ingredient dispensing mechanism 301 (also see FIG. 10). Then a cooked food is produced in the cookware 11. Then, as shown in FIG. 17 (also see FIG. 6B), a cooked food may be dispensed into a food container 182 through the funnel 181. The cookware cleaning mechanism 202 is positioned next to the cooking apparatus 103 and is configured to clean the cookware 11 (also see FIGS. 8C-8D).

The cooking apparatus 103 in the cooking system 901 may be referred to as a first cooking apparatus. Said first cooking apparatus 103 comprises a first motion apparatus comprising: the stirring mechanism 102, referred to as a first motion mechanism; and the unloading mechanism 170, referred to as a second motion mechanism. The stirring mechanism 102 can move the cookware 11 of the first cooking apparatus 103 as to stir or mix the food or food ingredients in the cookware 11 of the first cooking apparatus 103 during a cooking process. The unloading mechanism 170 may rotate the support component 149 (of the stirring mechanism 102) and thus turn the cookware 11 as to dispense a cooked food from the cookware 11 to a food container 182 held in the receiving apparatus 104.

The cooking apparatus 403 in the cooking system 901 may be referred to as a second cooking apparatus. The second cooking apparatus 403 comprises a second motion apparatus comprising: the rotational motion mechanism 410, referred to as a third motion mechanism; the vertical motion mechanism 420, referred to as a fourth motion mechanism, which may move the component 413 together with the basket 41 linearly in the vertical position. When the component 413 is moved to a second end position by said fourth motion mechanism, then the third motion mechanism 410 may turn the basket 41 as to dispense a semi-cooked food from the basket 41 of the cooking apparatus 403 to the cookware 11 of the cooking apparatus 103.

The computer system 99 is connected to the mechanisms and devices 161, 16, 13, 172, 188, 212, 226, 234, 253, 344a, 344b, 348, 323, 411, 414, 47, 421, 212c and 212d. The computer system 99 is also connected to the transport system 302 as to control the movements of the vehicles 790 of the transport system 302.

In the cooking system 901, the cooking apparatus 103 is positioned near the following mechanisms and apparatuses: the receiving apparatus 104; the cookware cleaning mechanism 202; the lid apparatus 203, the cooking apparatus 403; the ingredient dispensing mechanism 301 which is next to the transport system 302. The cooking apparatus 403 is positioned near the second ingredient dispensing mechanism 301b and the cooking apparatus 103.

The computer system 99 comprises a memory. The computer system configured to store various data in the computer system's memory.

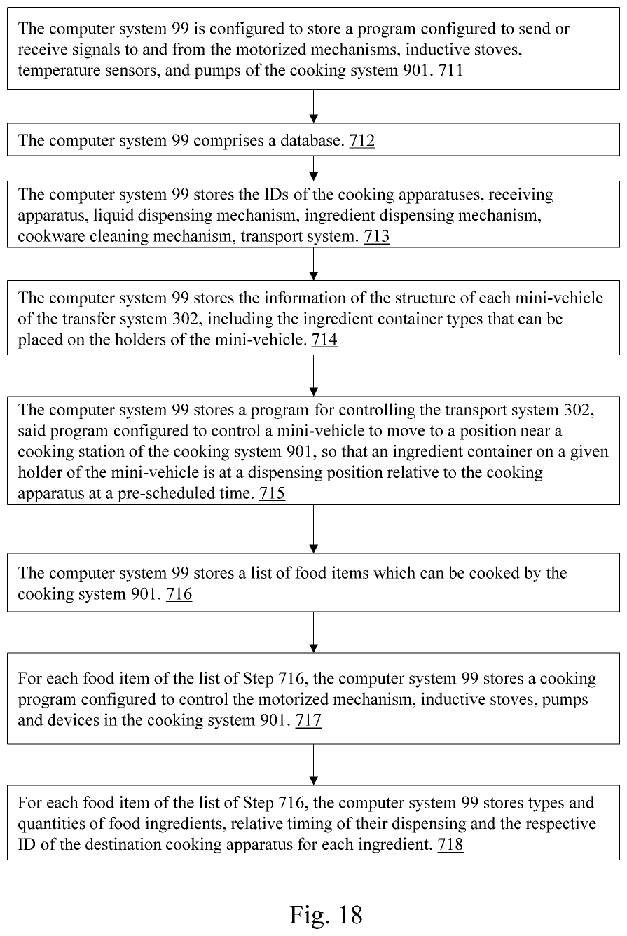

Referring to FIG. 18, the following tasks are performed by the computer system 99 prior to the operation of the cooking system 901.

In Step 711, the computer system 99 stores (in the computer system's memory) a program, configured to send or receive signals to and from the motorized mechanisms, inductive stoves, temperature sensors and pumps of the cooking system 901.

In Step 712, a database is installed in the computer system 99.

In Step 713, each of the cooking apparatuses, receiving apparatus, liquid dispensing mechanisms, ingredient dispensing mechanisms, cookware cleaning mechanism, transport system is assigned a unique ID. The computer system 99 stores the IDs of these apparatuses and mechanisms.

In Step 714, the computer system 99 stores the information of the structure of each vehicle of the transport system 302, including the ingredient container types that can be placed on the holders of the vehicle.

In Step 715, the computer system 99 stores a program for controlling the transport system 302. The program is configured to control a vehicle so the vehicle may move and stop at a pre-scheduled time at a position near a cooking apparatus of the cooking system 901, where a container on a given holder of the vehicle is at a dispensing position relative to the cooking apparatus.

In Step 716, the computer system 99 stores a list of foods which may be cooked by the cooking system 901.

In Step 717, for each food item in the list of Step 716, the computer system 99 stores a cooking program configured to control the motorized mechanism, inductive stoves, pumps and devices in the cooking system 901.

In Step 718, for each food item in the list of Step 716, the computer system 99 stores types and quantities of food ingredients, relative timing of their dispensing and the respective ID of the destination cooking apparatus for each ingredient to be dispensed into; wherein the relative timing refers to the timing relative to the timing of the program of Step 717 corresponding to the food. Food ingredients contained in a container is to be dispensed into a basket or cookware in the destination cooking apparatus.

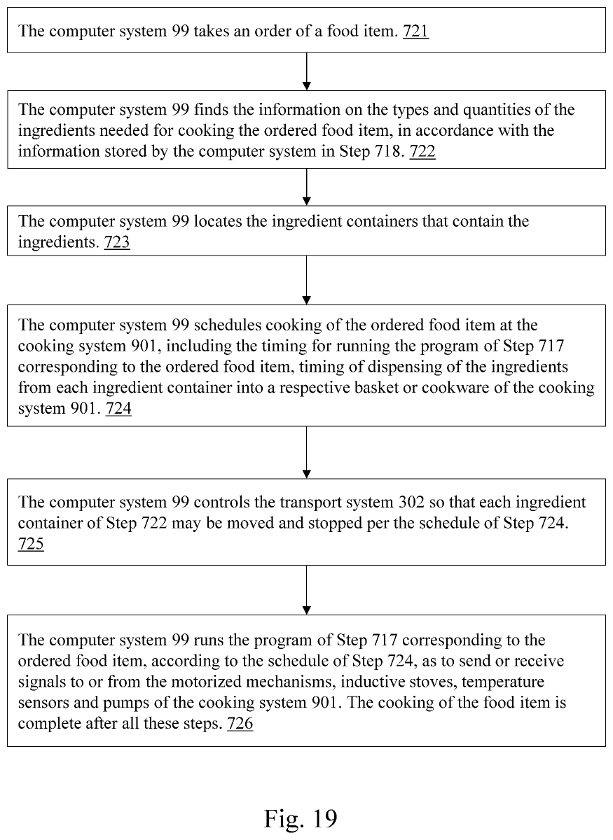

Referring to FIG. 19, the following tasks are routinely performed by the computer system 99 during the operation of the cooking system 901.

In Step 721, the computer system 99 takes an order of a food. The order may be placed by a human either at the computer system 99, or at a computer which sends the order to the computer system 99.

In Step 722, for the ordered food of Step 721, the computer system 99 finds the information on the types and quantities of the ingredients needed for cooking the ordered food. Such information was stored by the computer system 99 in Step 718.

In Step 723, the computer system 99 locates the ingredient containers that contain the food ingredients found in Step 722. The ingredients may be dispensed from some larger containers into said ingredient containers. Alternatively, ingredients may already be in the ingredient containers, and their locations had been stored in the memories of the computer system 99.

In Step 724, the computer system 99 schedules the cooking of the ordered food at cooking system 901. The schedule includes the timing for running the program of Step 717 corresponding to the ordered food. The schedule also includes the timing of dispensing of the ingredients from each ingredient container into a respective basket or cookware of the cooking system 901, in accordance to the stored information by the computer system 99 in Step 718.

In Step 725, the computer system 99 controls the transport system 302 so that each ingredient container of Step 722 may be moved and stopped per the schedule of Step 724.

In Step 726, the computer system 99 runs the program of Step 717 corresponding to the ordered food, according to the schedule of Step 724, as to send or receive signals to or from the motorized mechanisms, inductive stoves, temperature sensors and pumps of the cooking system 901.

After all these steps, the cooking of the food, including dispensing of the cooked food to a food container, is complete.

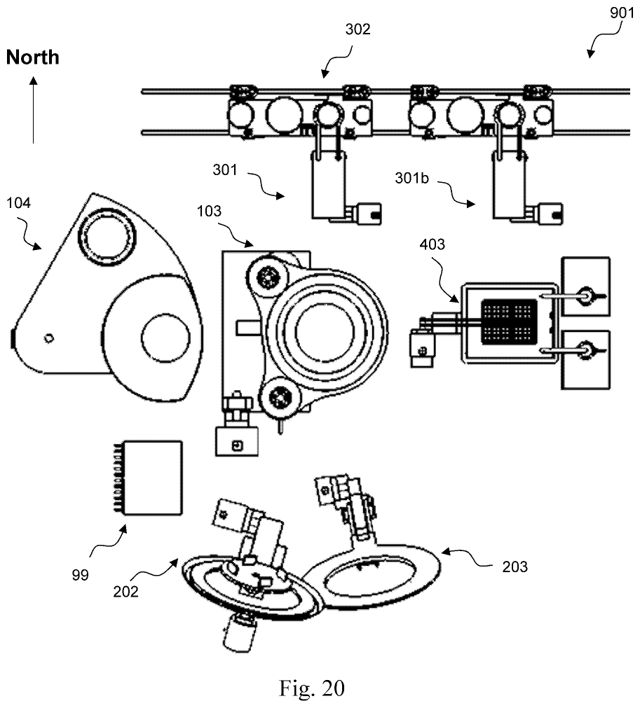

It should be noted that the 3-dimensional positioning of the mechanisms and apparatuses in the cooking system 901 can be done in various ways. For example, the receiving apparatus 104, the cookware cleaning mechanism 202, the ingredient dispensing mechanism 301 and the cooking apparatus 403 may be respectively positioned on the Western, Southern, Northern and Eastern sides of the cookware 11 of the cooking apparatus 103; and the lid apparatus 203 may be positioned in the Southeastern side of the cookware 11. The second ingredient dispensing mechanism 301b may be positioned on the Northern side of the cooking apparatus 403. See FIG. 20.

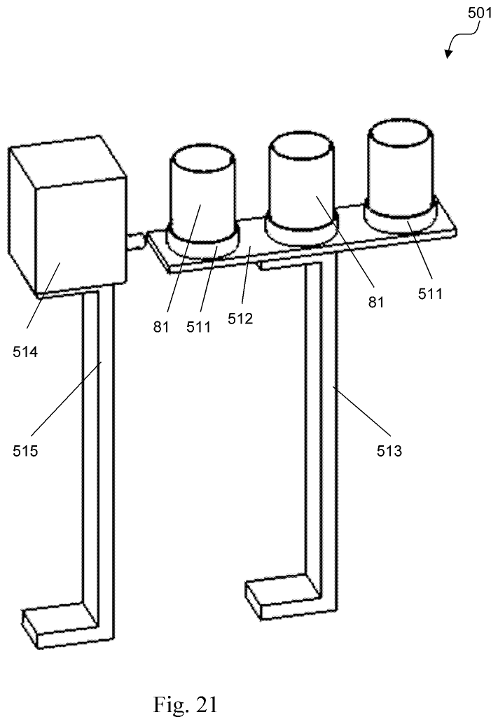

Referring to FIG. 21, a storage apparatus 501 comprises: a plurality of container holders 511; and a support component 512; wherein each container holder 511 is configured to hold one or more ingredient containers 81. Each container holder 511 is fixedly connected to the support component 512. The support component 512 is rigidly connected to the ground by a rigid connector 513. The storage apparatus 501 also comprises a refrigeration mechanism 514 configured to refrigerate the ingredient containers 81 as to keep the food ingredient in the containers fresh. The refrigeration mechanism 514 is fixedly connected to the ground by a rigid connector 515.

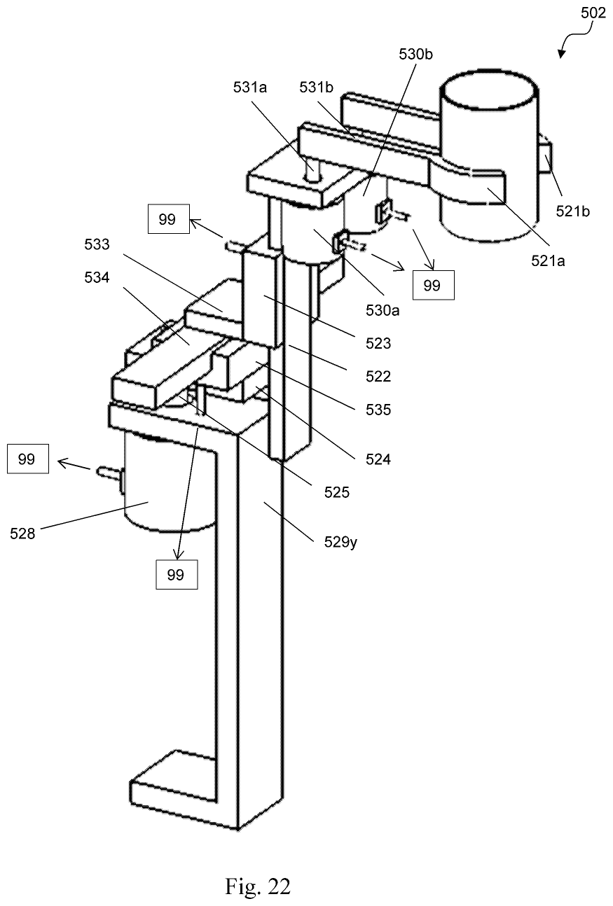

Referring to FIG. 22, a loading mechanism 502 comprises: gripping devices 521a and 521b; a shaft 531a rigidly connected to the gripping device 521a; a shaft 531b rigidly connected to the gripping device 521b; a motorized mechanism 530a configured to produce a rotation in the shaft 531a around a vertical axis (which is the same as the axis of the shaft 531a), wherein the motorized mechanism 530a is connected to the computer system 99 by wires, wherein the computer system 99 is configured to control the motorized mechanism 530a; a motorized mechanism 530b configured to produce a rotation in the shaft 531b around a vertical axis (which is the same as the axis of the shaft 531b), wherein the motorized mechanism 530b is connected to the computer system 99 by wires, wherein the computer system 99 is configured to control the motorized mechanism 530b. The (base components of the) motorized mechanism 530a and 530b are rigidly connected to a slider 522. The motorized mechanism 530a and 530b may produce an anti-synchronous rotation in the gripping device 521a and respectively 521b. The gripping devices 521a and 521b may be rotated between some end-positions. At a first end-positions, the gripping devices 521a and 521b may work together to grip a container under the condition that the container is placed in a certain position relative to the slider 522. At the second end-position, the gripped container is let free from the gripping devices 521a and 521b.

The loading mechanism 502 further comprises a vertical motion mechanism 523 configured to produce a back-and-forth vertical linear motion in the slider 522 between a lower end-position and an upper end-position. The vertical motion mechanism 523 is connected to the computer system 99, wherein the computer system 99 is configured to control the motion of the slider 522. The loading mechanism 502 further comprises a horizontal motion mechanism 535; a connector 533; a slider 534. The horizontal motion mechanism 535 is configured to produce horizontal linear motion in the slider 534, wherein the slider 534 rigidly connects to the vertical motion mechanism 523 via the connector 533, so that the horizontal motion mechanism 535 is configured to produce horizontal linear motion in the vertical motion mechanism 523. The horizontal motion mechanism 535 is connected to the computer system 99, wherein the computer system 99 is configured to control the motion of the slider 534. The loading mechanism 502 further comprises: a shaft 525 which is connected to (a base component of) the horizontal motion mechanism 535 by a rigid connector 524 wherein the axis of the shaft 525 is vertical; a motorized mechanism 528 configured to produce a rotation in the shaft 525 around the axis of the shaft 525; a rigid connector 529y configured to connect (a base component of) the motorized mechanism 528 to the ground. The axis of the shaft 525 is vertical. The motorized mechanism 528 is configured to produce a back-and-forth rotation in the shaft 525 and hence in the (base component of the) horizontal motion mechanism 535, between two end-positions, around the axis of the shaft 525. It should be noted that the rigid connector 529y may be referred as the support component of the loading mechanism 502.

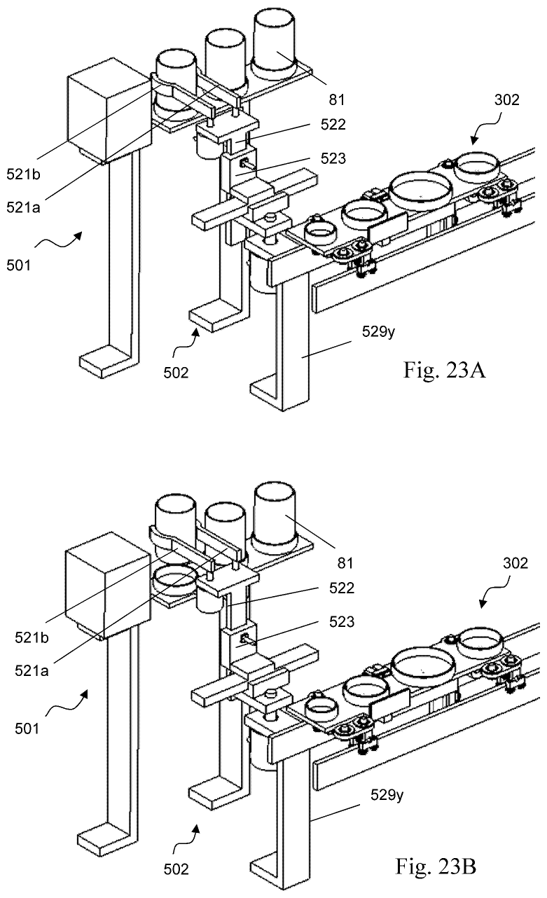

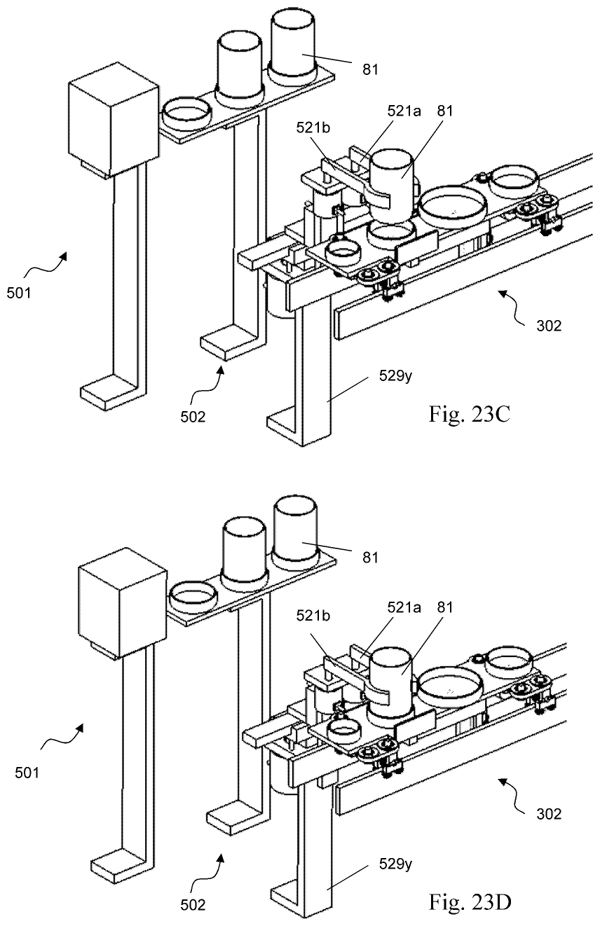

FIGS. 23A-23D show the relative position of the storage apparatus 501, the loading mechanism 502 and the transport system 302. A vehicle 790 of the transport system 302 moves to a certain position relative to the support component 529y of the loading mechanism 502. When the shaft 525 (or the horizontal motion mechanism 535) is at a first end-position of the shaft 525 in the back-and-forth rotation produced by the motorized mechanism 528, and when the slider 522 is at the lower end-position in the vertically linear sliding produced by the vertical motion mechanism 523, and when the slider 534 is sliding to a certain position by the horizontal motion mechanism 535, the gripping devices 521a and 521b, when rotated to their first end-positions relative to the slider 522, may grip a container, in an upright position, which contains food or food ingredients, under the condition that the container is at a certain position relative to the support component 529y (see FIG. 23A). Then, the slider 522 is vertically slid to the upper end-position while the container is gripped by the gripping devices 521a and 521b (see FIG. 23B). And then, the shaft 525 and the vertical motion mechanism 523 are rotated by the motorized mechanism 528 to the second end-position while the container is gripped by the gripping devices 521a and 521b (see FIG. 23C). Then, the slider 522 is vertically slid to the lower end-position, and then the gripping devices 521a and 521b, when rotated to their second end-positions by the motorized mechanism 530a and 530b respectively, may release the container to a container holder 785a of a vehicle 790 (see FIG. 23D). The computer system 99 may control the timing and speed of the motorized mechanisms 528, the horizontal motion mechanism 535 and the vertical motion mechanism 523. It should be noted that the vehicle 790 is braked during the time of the above procedures.

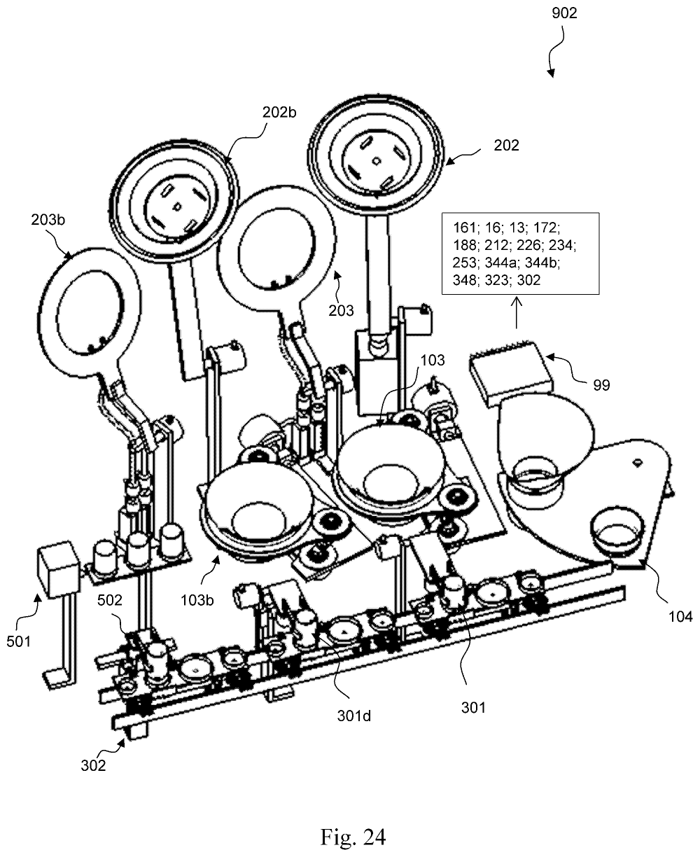

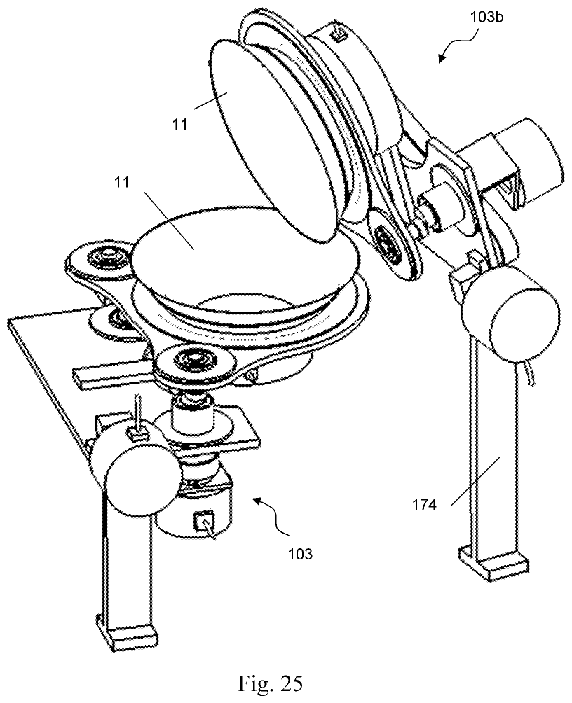

In some embodiments, referring to FIGS. 24-25, a cooking system 902 comprises (from left to right): a receiving apparatus 104; a first lid apparatus 203; a first cookware cleaning mechanism 202; a first cooking apparatus 103; a first ingredient dispensing mechanism 301; a transport system 302; a second cookware cleaning mechanism 202b; a second cooking apparatus 103b; a second lid apparatus 203b; a second ingredient dispensing mechanism 301d; a storage apparatus 501; a loading mechanism 502; and a computer system 99.

Said first cooking apparatus 103 comprises: the stirring mechanism 102, referred to as a first motion mechanism; and the unloading mechanism 170, referred to as a second motion mechanism wherein the stirring mechanism 102 may move the cookware 11 of the first cooking apparatus 103 as to stir or mix the food or food ingredients in the cookware 11 of the first cooking apparatus 103 during a cooking process; wherein the unloading mechanism 170 can rotate the support component 149 of the stirring mechanism 102 and thus turn the cookware 11 as to dispense a cooked food from the cookware 11 to a food container 182 held in the receiving apparatus 104.

Said second cooking apparatus 103b is a copy of said cooking apparatus 103. The part numbers in the cooking apparatus 103b are the same as the corresponding part numbers in the cooking apparatus 103. Thus said second cooking apparatus 103b comprises a cookware 11, referred to as a second cookware and a second motion apparatus, wherein said second motion apparatus comprises: a stirring motion mechanism 102, referred to as a third a stirring mechanism 102, which may move said second cookware 11 as to stir or mix the food or food ingredients held in the cookware 11 during a cooking process; and an unloading mechanism 170, referred to as the fourth motion mechanism, which may turn said support component 149 of the stirring mechanism 102 and thus move said second cookware 11 as to dispense a semi-cooked food from said second cookware 11 to the first cookware 11 of the first cooking apparatus 103.

Said loading mechanism 502 may load an ingredient container 81 containing food ingredients from the storage apparatus 501 to a vehicle 790 in the transport system 302. The vehicle 790 may move to a location next to the cooking apparatuses as to be gripped by the dispensing mechanism corresponding to the cooking apparatus. The timing of arrival of the vehicle 790 at said location is controlled by the computer system 99.

Said first lid apparatus 203 may dispense liquid ingredients into the cookware 11 (also shown in FIG. 7C). The second lid apparatus 203b is a copy of lid apparatus 203 but is positioned next the second cooking apparatus 103b, as to dispense liquid ingredients into the cookware 11 of the cooking apparatus 103b. The part numbers in the lid apparatus 203b are the same as the corresponding part numbers in the lid apparatus 203. The first ingredient dispensing mechanism 301 is positioned next the cooking apparatus 103, as to dispense food ingredients from an ingredient container on a holder of the transport system 302 to the cookware 11 (also shown in FIG. 10). The second ingredient dispensing mechanism 301d is a copy of the ingredient dispensing mechanism 301 but is positioned next the cooking apparatus 103b. The part numbers in the mechanism 301d are the same as the corresponding part numbers in the mechanism 301. Similar to the ingredient dispensing mechanism 301 (also shown in FIG. 10), the ingredient dispensing mechanism 301d may dispense food ingredients from an ingredient container on a holder of the transport system 302 to the cookware 11 of the cooking apparatus 103b.

The food ingredients dispensed into the cookware 11 of the cooking apparatus 103b are cooked therein, as to produce a semi-cooked food. Then, the semi-cooked food contained in the cookware 11 of the cooking apparatus 103b is dispensed into the cookware 11 of the cooking apparatus 103, when the cookware 11 of the cooking apparatus 103b is rotated from the first end-position to the second end-position relative to the support component 149 of the cooking apparatus 103b (see FIG. 25). Then the semi-cooked food is further cooked by the cooking apparatus 103, possibly together with other ingredients, some of which are dispensed from an ingredient container on a holder of the transport system 302 by the first ingredient dispensing mechanism 301. Then, a cooked food is produced in the cookware 11 of the cooking apparatus 103. Then, the cooked food is dispensed into a food container 182 held in the receiving apparatus 104 (see also FIG. 6B).

The cookware cleaning mechanism 202 is positioned next to the cooking apparatus 103 and may clean the cookware 11 of the cooking apparatus 103 (also see FIGS. 8C-8D). The second cookware cleaning mechanism 202b is a copy of the cookware cleaning mechanism 202; and it may clean the cookware 11 of the cooking apparatus 103b.

The computer system 99 is connected to the apparatuses, mechanisms and devices 161, 16, 13, 172, 188, 212, 226, 234, 253, 344a, 344b, 348, 323, 501 and 502. The computer system 99 is also connected to the transport system 302 as to control the movements of the vehicles 790 of the transport system 302.

In cooking system 902, the cooking apparatus 103 needs to be positioned near the following mechanisms and apparatuses: the receiving apparatus 104; the first cookware cleaning mechanism 202; the lid apparatus 203; the ingredient dispensing mechanism 301 which is positioned next to the transport system 302; and the second cooking apparatus 103b. The second cooking apparatus 103b is positioned near the following: the first cooking apparatus 103; the second cookware cleaning mechanism 202b; the second lid apparatus 203b; and the second ingredient dispensing mechanism 301d.

It should be noted that in the cooking system 902, the second cooking apparatus 103b may be substituted by a cooking apparatus that is different from the first cooking apparatus 103. For example, the second cookware of the second cooking apparatus 103b may be substituted by a cookware which has a different size and/or shape from the first cookware of the first cooking apparatus 103.

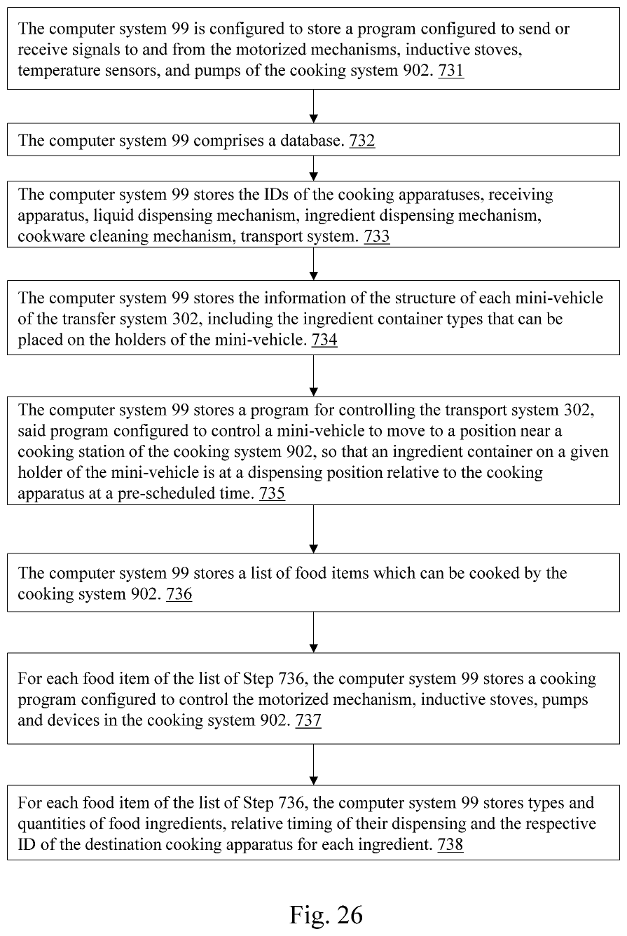

Referring to FIG. 26, the following tasks are performed by the computer system 99 prior to the operation of the cooking system 902.

In Step 731, the computer system 99 stores (in the computer system's memory) a program, configured to send or receive signals to and from the motorized mechanisms, inductive stoves, temperature sensors and pumps of the cooking system 902.

In Step 732, a database is installed in the computer system 99.

In Step 733, each of the cooking apparatuses, receiving apparatus, liquid dispensing mechanisms, ingredient dispensing mechanisms, cookware cleaning mechanisms, transport system is assigned a unique ID. The computer system 99 stores the IDs of these apparatuses and mechanisms.

In Step 734, the computer system 99 stores the information of the structure of each vehicle of the transport system 302, including the ingredient container types that can be placed on the holders of the vehicle.

In Step 735, the computer system 99 stores a program for controlling the transport system 302. The program may be used to control a vehicle so the vehicle may move and stop at a pre-scheduled time at a position near a cooking apparatus of the cooking system 902, where a container on a given holder of the vehicle is at a dispensing position relative to the cooking apparatus.

In Step 736, the computer system 99 stores a list of food items which may be cooked by the cooking system 902.

In Step 737, for each food item in the list of Step 736, the computer system 99 stores a cooking program configured to control the motorized mechanism, inductive stoves, pumps and devices in the cooking system 902.

In Step 738, for each food item in the list of Step 736, the computer system 99 stores types and quantities of food ingredients, relative timing of their dispensing and the respective ID of the destination cooking apparatus for each ingredient to be dispensed into; wherein the relative timing refers to the timing relative to the timing of the program of Step 737 corresponding to the food item. Food ingredients contained in a container is to be dispensed into a basket or cookware in the destination cooking apparatus.

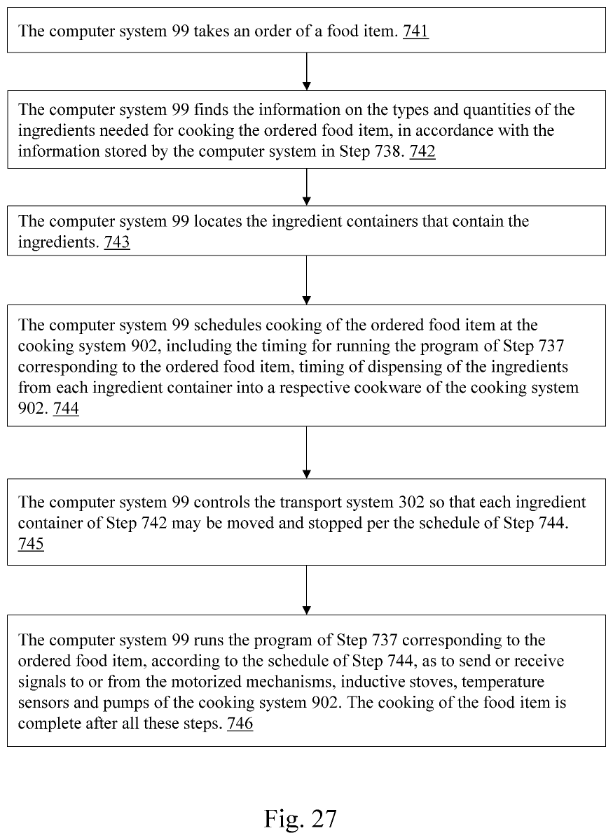

Referring to FIG. 27, the following tasks are routinely performed by the computer system 99 during the operation of the cooking system 902.

In Step 741, the computer system 99 takes an order of a food item. The order may be placed by a human either at the computer system 99, or at a computer which sends the order to the computer system 99.

In Step 742, for the ordered food item of Step 741, the computer system 99 finds the information on the types and quantities of the ingredients needed for cooking the ordered food item. Such information was stored by the computer system 99 in Step 738.

In Step 743, the computer system 99 locates the ingredient containers that contain the food ingredients found in Step 742. The ingredients may be dispensed from some larger containers into said ingredient containers. Alternatively, ingredients may already be in the ingredient containers, and their locations had been stored in the memories of the computer system 99.

In Step 744, the computer system 99 schedules the cooking of the ordered food item at cooking system 902. The schedule includes the timing for running the program of Step 737 corresponding to the ordered food item. The schedule also includes the timing of dispensing of the ingredients from each ingredient container into a respective cookware of the cooking system 902, in accordance to the stored information by the computer system 99 in Step 738.

In Step 745, the computer system 99 controls the transport system 302 so that each ingredient container of Step 742 may be moved and stopped per the schedule of Step 744.

In Step 746, The computer system 99 runs the program of Step 737 corresponding to the ordered food item, according to the schedule of Step 744, as to send or receive signals to or from the motorized mechanisms, inductive stoves, temperature sensors and pumps of the cooking system 902.

After all these steps, the cooking of the food item, including dispensing of the cooked food to a food container, is complete.

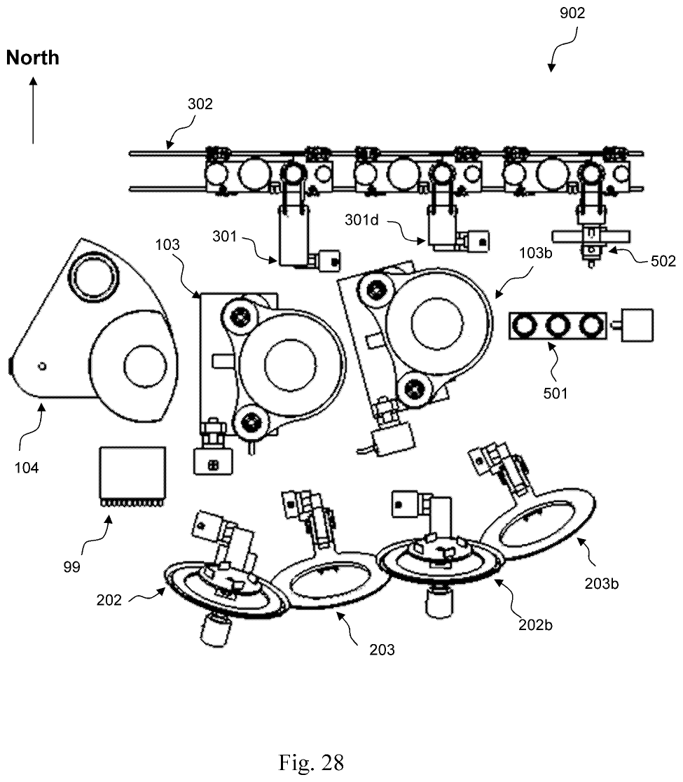

The 3-dimensional positioning of these mechanisms and apparatuses in the cooking system 902 can be done in various ways. For example, the receiving apparatus 104, the cookware cleaning mechanism 202, the ingredient dispensing mechanism 301 and the second cooking apparatus 103b may be respectively positioned on the Western, Southern, Northern and Eastern sides of the cookware 11 of the cooking apparatus 103; and the lid apparatus 203 may be positioned in the Southeastern side of the cookware 11. The second cookware cleaning mechanism 202b, the second ingredient dispensing mechanism 301d and the second lid apparatus 203b may be positioned on the Southeastern of the cooking apparatus 103. See FIG. 28.

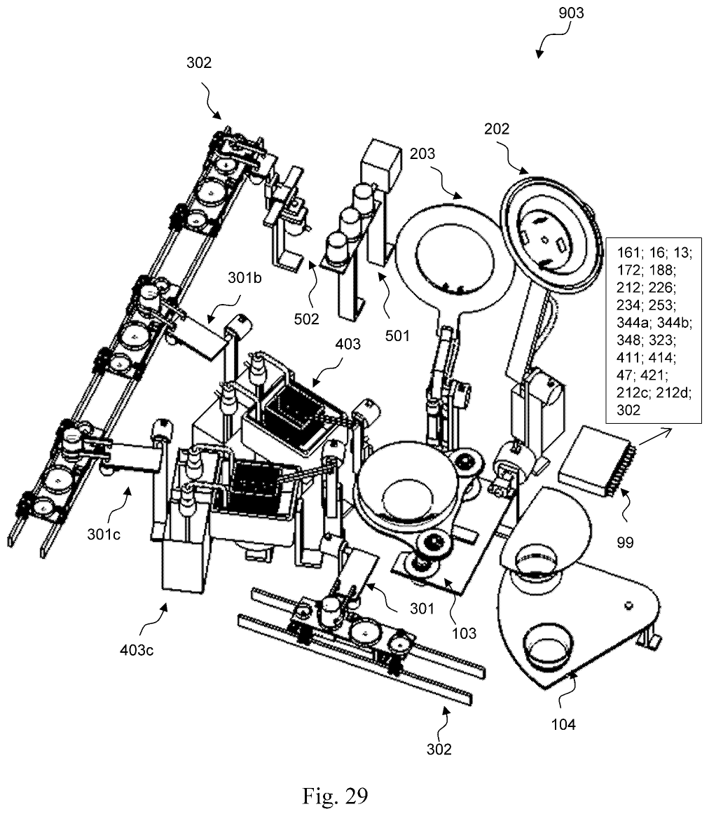

In some embodiments, referring to FIGS. 29-34, a cooking system 903 comprises (from left to right): a receiving apparatus 104; a cookware cleaning mechanism 202; a lid apparatus 203; a cooking apparatus 103; a first ingredient dispensing mechanism 301; a transport system 302; a cooking apparatus 403; a cooking apparatus 403c; a second ingredient dispensing mechanism 301b; a third ingredient dispensing mechanism 301c; a storage apparatus 501; a loading mechanism 502; and a computer system 99. The cooking apparatus 403c is a copy of the cooking apparatus 403 with the same part numbers, except that the liquid in the liquid container 45 in the cooking apparatus 403c can be different from the liquid in the liquid container 45 of the cooking apparatus 403. The lid apparatus 203 may dispense liquid ingredients into the cookware 11 (as shown in FIG. 7C). The first ingredient dispensing mechanism 301 is positioned next the cooking apparatus 103, as to dispense food ingredients into the cookware 11 of the cooking apparatus 103 (as shown in FIG. 10). The second ingredient dispensing mechanism 301b is a copy of the ingredient dispensing mechanism 301 but is positioned next the cooking apparatus 403. The part numbers in the mechanism 301b are the same as the corresponding part numbers in the mechanism 301. The third ingredient dispensing mechanism 301c is a copy of the ingredient dispensing mechanism 301 but is positioned next the cooking apparatus 403c. The part numbers in the third ingredient dispensing mechanism 301c are the same as the corresponding part numbers in the ingredient dispensing mechanism 301.

The loading mechanism 502 may load an ingredient container 81 containing food ingredients from the storage apparatus 501 to a vehicle 790 in the transport system 302. The vehicle 790 may move to a location next to the cooking apparatuses as to be gripped by the dispensing mechanism corresponding to the cooking apparatus. The timing of arrival of the vehicle 790 at said location is controlled by the computer system 99.

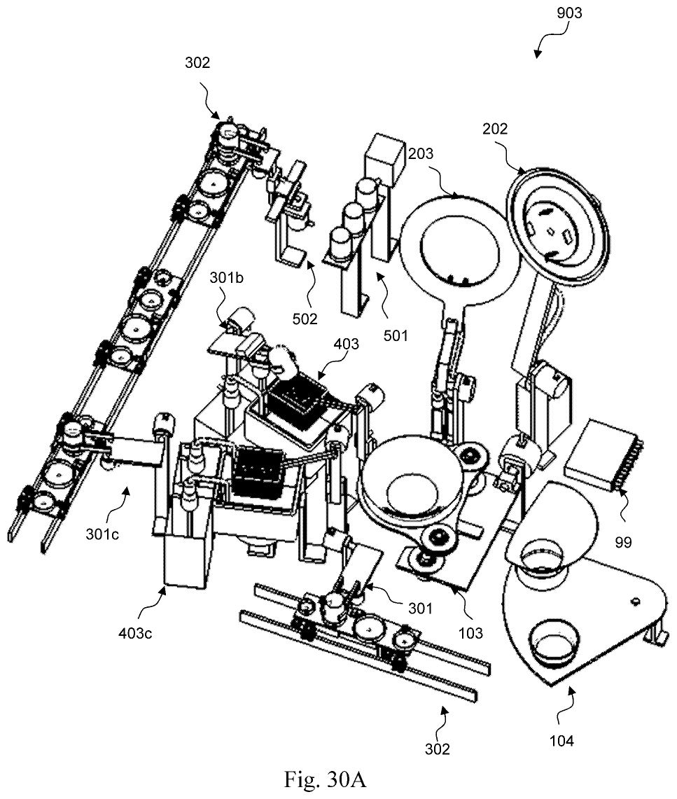

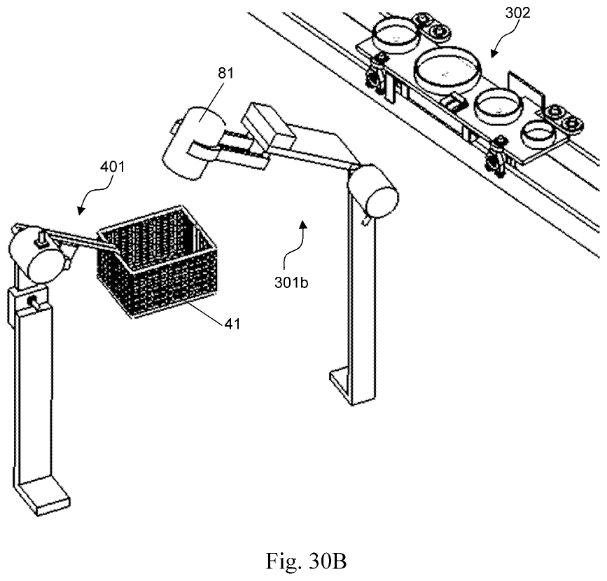

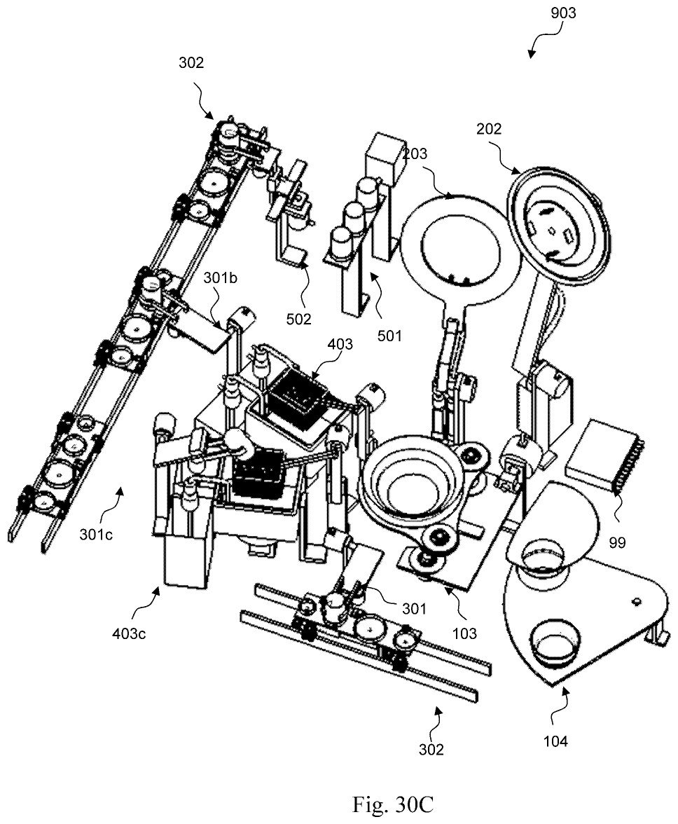

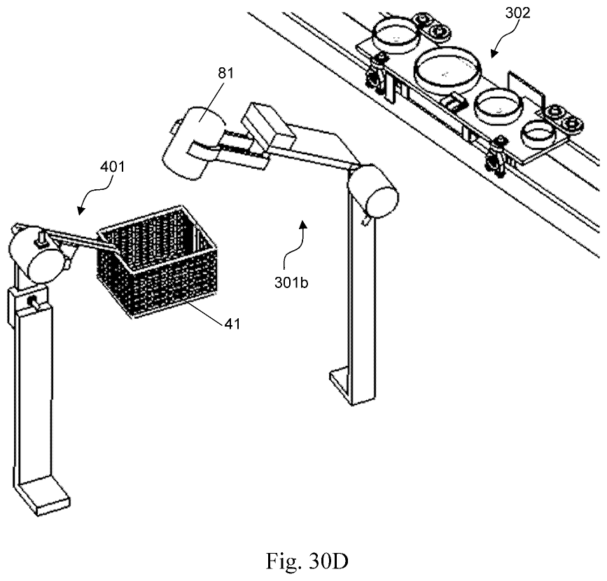

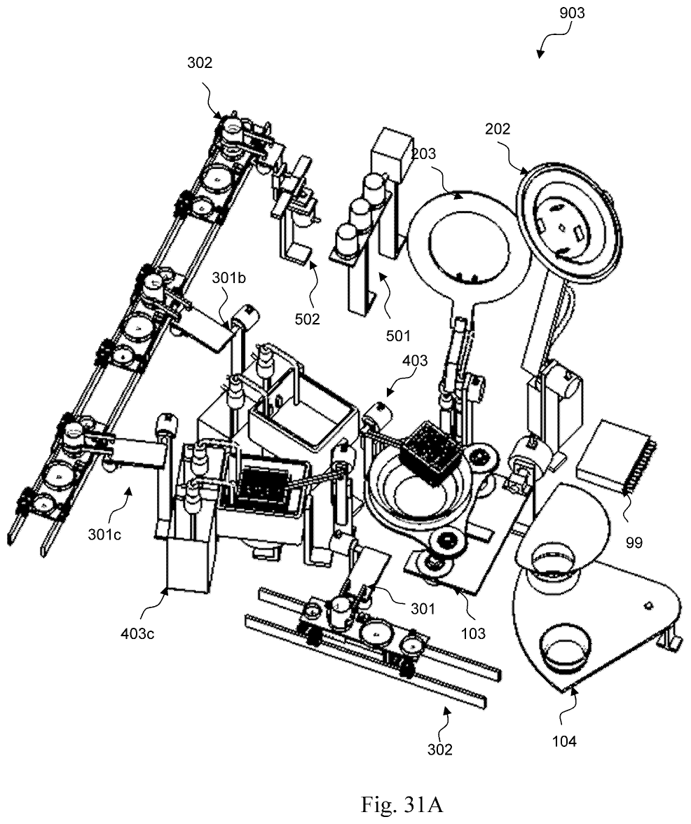

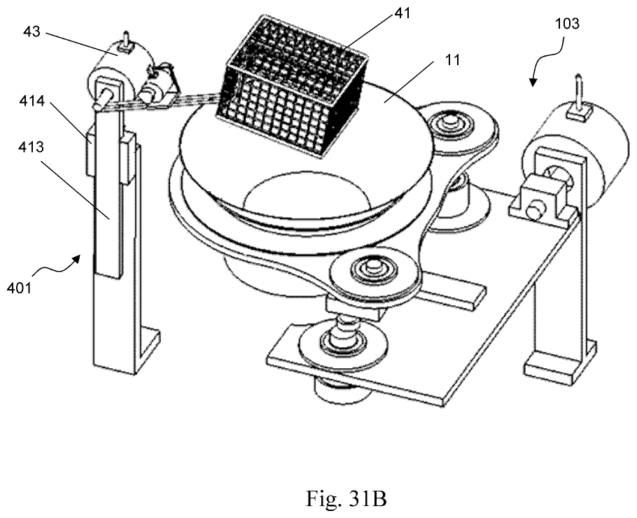

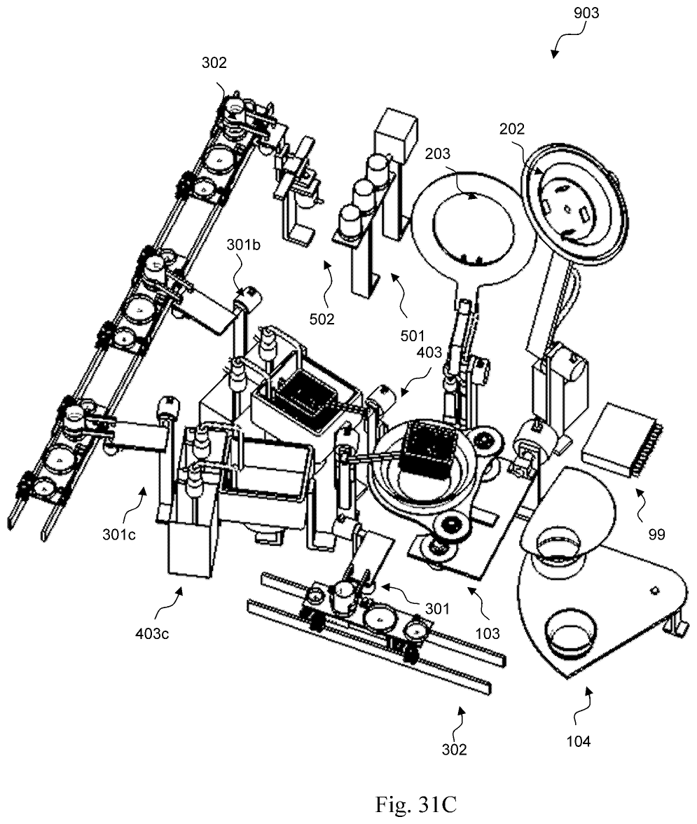

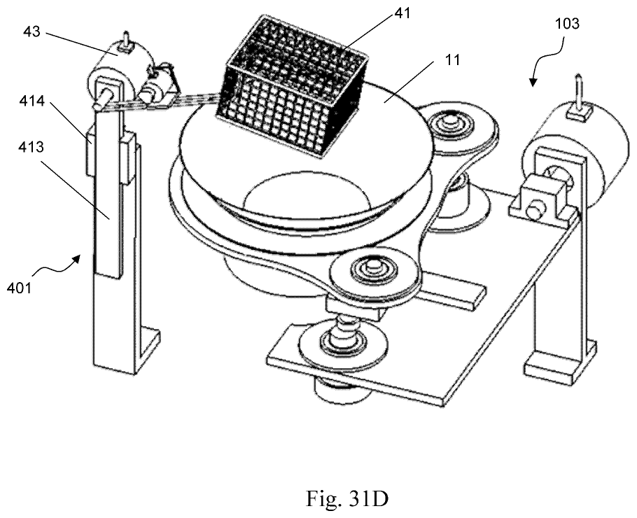

As shown in FIGS. 30A-30B, the gripping devices of the ingredient dispensing mechanism 301b may be moved to grip an ingredient container 81 containing food ingredients and then rotate the container 81 as to dispense the food ingredients from the container 81 into the basket 41 of the cooking apparatus 403. Meanwhile the basket 41 of the cooking apparatus 403 is at the first end-position relative to the sliding component 413 of the cooking apparatus 403; and the sliding component 413 is at the second end-position relative to the support component 415 in the cooking apparatus 403 (or equivalently, relative to the ground). Then, the sliding component 413 is moved down to the first end-position, so that the basket 41 holding the food ingredients may be immersed in a hot liquid in the liquid container 45 of the cooking apparatus 403. The food ingredients in the basket are cooked in the hot liquid, as to produce a semi-cooked food. Then, the sliding component 413 is moved upward to the second end-position and the basket 41 is lifted up and away from the hot liquid in the liquid container 45. The basket 41 may be left at this position for another period of time, during which the vibration device 48 may produce micro-vibrations in the basket 41 as to let the hot liquid attached to the basket 41 and the semi-cooked food to drip into the liquid container 45. Then, as shown in FIGS. 31A-31B, the semi-cooked food contained in the basket 41 may be dispensed into the cookware 11 of the cooking apparatus 103 when the basket 41 is rotated from the first end-position to the second end-position relative to the sliding component 413 which stays at the second end-position.

Similarly, as shown in FIGS. 30C-30D, the gripping devices of the ingredient dispensing mechanism 301c may be moved to grip an ingredient container 81 containing food ingredients and then rotate the container as to dispense the food ingredients from the container 81 into the basket 41 of the cooking apparatus 403c. Meanwhile the basket 41 of the cooking apparatus 403c is at the f901irst end-position relative to the sliding component 413 of the cooking apparatus 403c; and the sliding component 413 is at the second end-position relative to the support component 415 in the cooking apparatus 403c (or equivalently, relative to the ground). Then, the sliding component 413 is moved down to the first end-position, so that the basket holding the food ingredients may be immersed in a hot liquid in the liquid container 45 of the cooking apparatus 403. The food ingredients in the basket 41 are cooked in the hot liquid, as to produce a semi-cooked food. Then, the sliding component 413 is moved upward to the second end-position and the basket 41 is lifted up and away from the hot liquid in the liquid container 45. The basket 41 may be left at this position for another period of time, during which the vibration device 48 may produce micro-vibrations in the basket 41 as to let the hot liquid attached to the basket 41 and the semi-cooked food to drip into the liquid container 45. Then, as shown in FIGS. 31C-31D, the semi-cooked food contained in the basket 41 may be dispensed into the cookware 11 of the cooking apparatus 103 when the basket 41 is rotated from the first end-position to the second end-position relative to the sliding component 413 which stays at the second end-position.

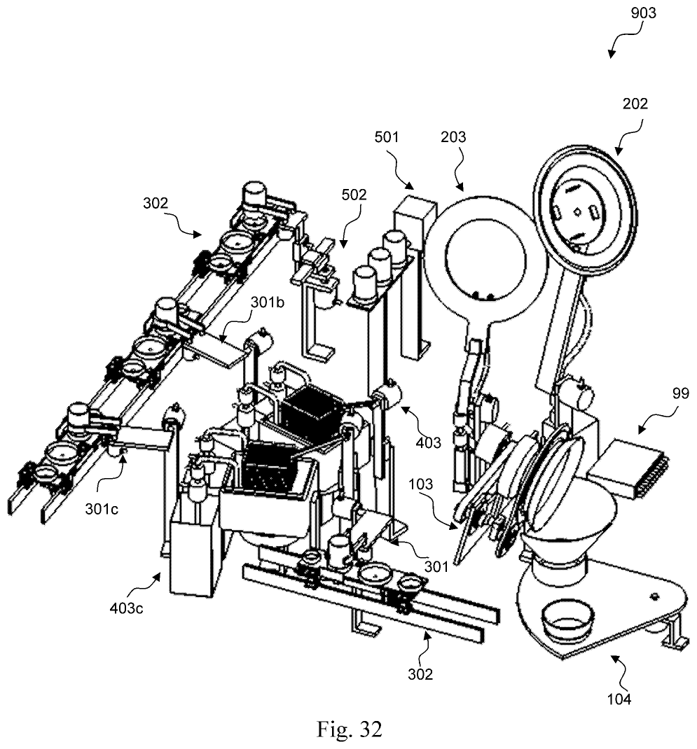

Then the semi-cooked foods dispensed from the cooking apparatuses 403 and 403c are further cooked by the cooking apparatus 103, possibly together with other ingredients, some of which are dispensed from an ingredient container on a holder of the transport system 302 by the first ingredient dispensing mechanism 301 (also see FIG. 10). Then a cooked food is produced in the cookware 11. Then, as shown in FIG. 32 (also see FIG. 6B), a cooked food may be dispensed into a food container 182 through the funnel 181.

The cookware cleaning mechanism 202 is positioned next to the cooking apparatus 103 and may clean the cookware 11 (also see FIGS. 8C-8D).

The computer system 99 is connected to the mechanisms and devices 161, 16, 13, 172, 188, 212, 226, 234, 253, 344a, 344b, 348, 323, 411, 414, 47, 421, 212c; 212d; 501; and 502. The computer system 99 is also connected to the transport system 302 as to control the movements of the vehicles of the transport system 302.

In cooking system 903, the cooking apparatus 103 is positioned near the following mechanisms and apparatuses: the receiving apparatus 104; the cookware cleaning mechanism 202; the lid apparatus 203; the cooking apparatus 403; the ingredient dispensing mechanism 301 which is next to the transport system 302; and the cooking apparatus 403c. The cooking apparatus 403 is positioned near the second ingredient dispensing mechanism 301b and the cooking apparatus 103. The cooking apparatus 403c is positioned near the third ingredient dispensing mechanism 301c and the cooking apparatus 103.

The computer system 99 comprises a memory. The computer system 99 is configured to store various data in the computer system's memory.

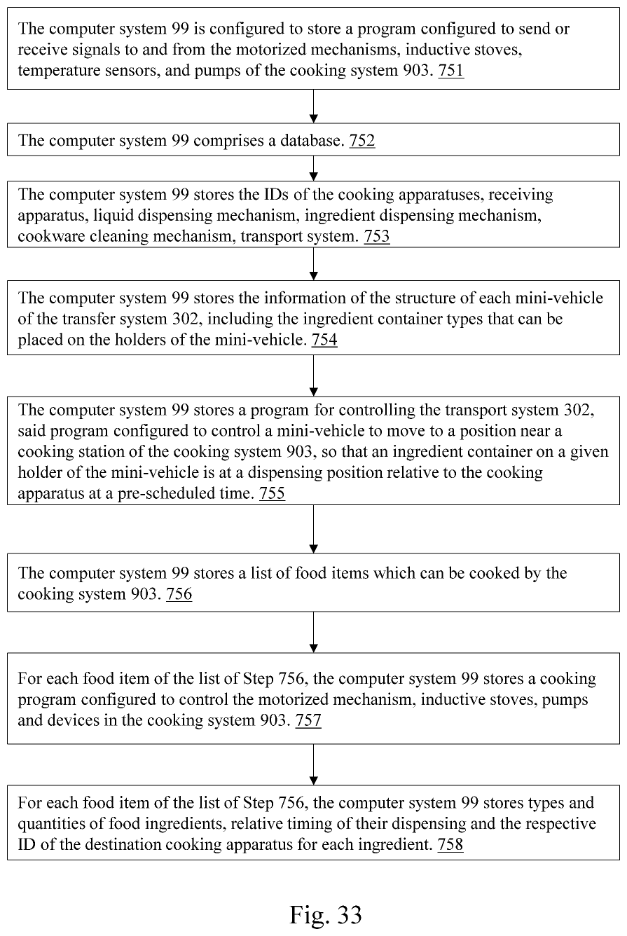

Referring to FIG. 33, the following tasks are performed by the computer system 99 prior to the operation of the cooking system 903.

In Step 751, the computer system 99 stores (in the computer system's memory) a program, configured to send or receive signals to and from the motorized mechanisms, inductive stoves, temperature sensors and pumps of the cooking system 903.

In Step 752, a database is installed in the computer system 99.

In Step 753, each of the cooking apparatuses, receiving apparatus, liquid dispensing mechanisms, ingredient dispensing mechanisms, cookware cleaning mechanism, transport system is assigned a unique ID. The computer system 99 stores the IDs of these apparatuses and mechanisms.

In Step 754, the computer system 99 stores the information of the structure of each vehicle of the transport system 302, including the ingredient container types that can be placed on the holders of the vehicle.

In Step 755, the computer system 99 stores a program for controlling the transport system 302. The program may be used to control a vehicle so that the vehicle may move and stop at a pre-scheduled time at a position near a cooking apparatus of the cooking system 903, where a container on a given holder of the vehicle is at a dispensing position relative to the cooking apparatus.

In Step 756, the computer system 99 stores a list of food items which may be cooked by the cooking system 903.

In Step 757, for each food item in the list of Step 756, the computer system 99 stores a cooking program configured to control the motorized mechanism, inductive stoves, pumps and devices in the cooking system 903.

In Step 758, for each food item in the list of Step 756, the computer system 99 stores types and quantities of food ingredients, relative timing of their dispensing and the respective ID of the destination cooking apparatus for each ingredient to be dispensed into; wherein the relative timing refers to the timing relative to the timing of the program of Step 757 corresponding to the food item. Food ingredients contained in a container is to be dispensed into a basket or cookware in the destination cooking apparatus.

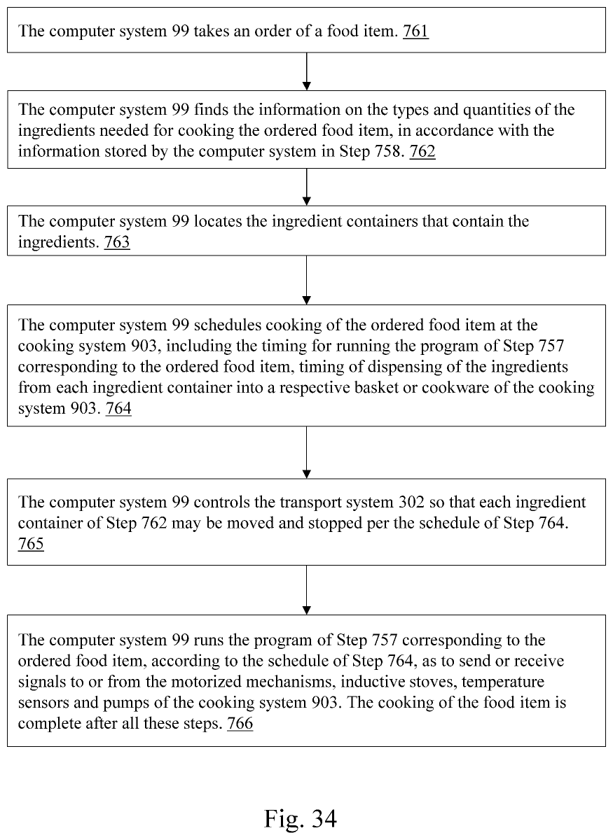

Referring to FIG. 34, the following tasks are routinely performed by the computer system 99 during the operation of the cooking system 903.

In Step 761, the computer system 99 takes an order of a food item. The order may be placed by a human either at the computer system 99, or at a computer which sends the order to the computer system 99.

In Step 762, for the ordered food item of Step 761, the computer system 99 finds the information on the types and quantities of the ingredients needed for cooking the ordered food item. Such information was stored by the computer system 99 in Step 758.

In Step 763, the computer system 99 locates the ingredient containers that contain the food ingredients found in Step 762. The ingredients may be dispensed from some larger containers into said ingredient containers. Alternatively, ingredients may already be in the ingredient containers, and their locations had been stored in the memories of the computer system 99.

In Step 764, the computer system 99 schedules the cooking of the ordered food item at the cooking system 903. The schedule includes the timing for running the program of Step 757 corresponding to the ordered food item. The schedule also includes the timing of dispensing of the ingredients from each ingredient container into a respective basket or cookware of the cooking system 903, in accordance to the stored information by the computer system 99 in Step 758.

In Step 765, the computer system 99 controls the transport system 302 so that each ingredient container of Step 762 may be moved and stopped per the schedule of Step 764.

In Step 766, The computer system 99 runs the program of Step 757 corresponding to the ordered food item, according to the schedule of Step 764, as to send or receive signals to or from the motorized mechanisms, inductive stoves, temperature sensors and pumps of the cooking system 903.

After all these steps, the cooking of the food item, including dispensing of the cooked food to a food container, is complete.

In some applications, the liquid in the liquid container 45 of the cooking apparatus 403 of the cooking system 903 may comprise cooking oil, while the liquid in the liquid container 45 of the cooking apparatus 403c may comprise water.

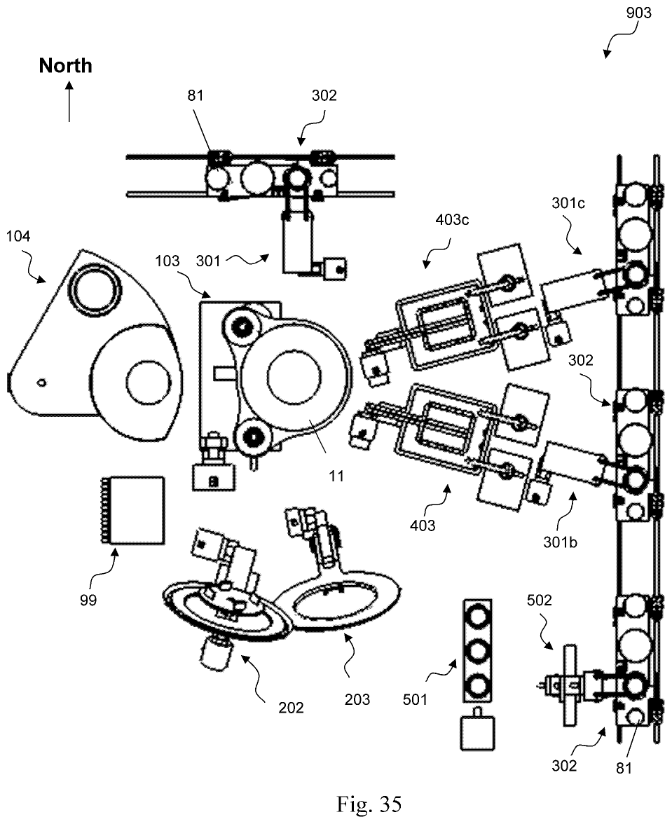

It should be noted that the 3-dimensional positioning of the mechanisms and apparatuses in the cooking system 903 can be done in various ways. For example, the receiving apparatus 104, the ingredient dispensing mechanism 301, the cooking apparatuses 403 and 403c may be respectively positioned on the Western, Northern and Eastern sides of the cookware 11 of the cooking apparatus 103; and the cookware cleaning mechanism 202, or the lid apparatus 203 may be positioned in the Southwestern, or respectively Southeastern side of the cookware 11. The ingredient dispensing mechanism 301b or 301c may be positioned on the Eastern side of the cooking apparatus 403 or respectively 403c. See FIG. 35.

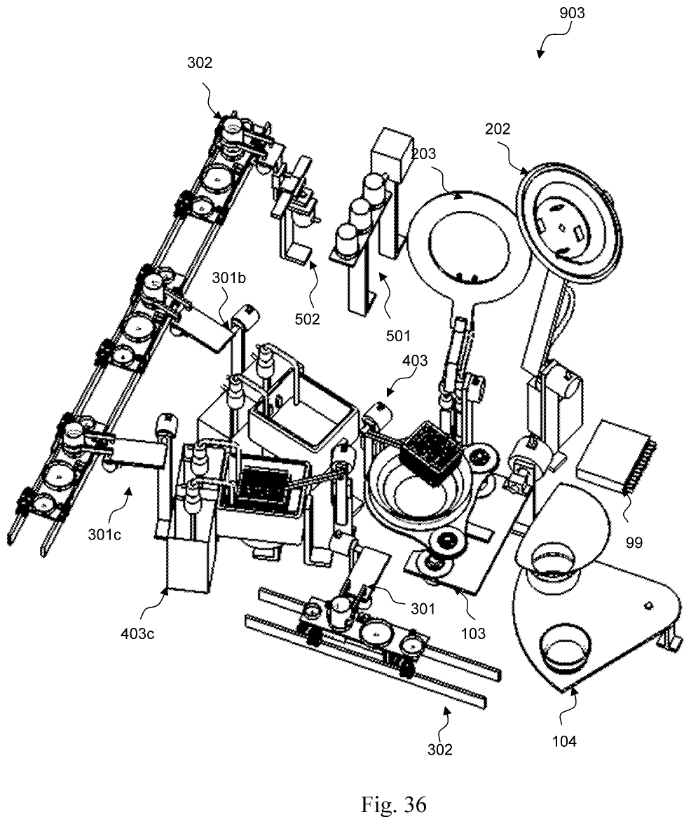

It should be noted that the transport system 302 in the above cooking systems may comprise a single connected system or a plurality of disconnected sub-systems. The transport system may comprise different types of vehicles. The ingredient containers may be configured differently for different types or quantities of ingredients. See FIGS. 35-36.

It should be noted that the drawings are schematic in nature and they may not accurately represent the relative sizes and positions of various parts.

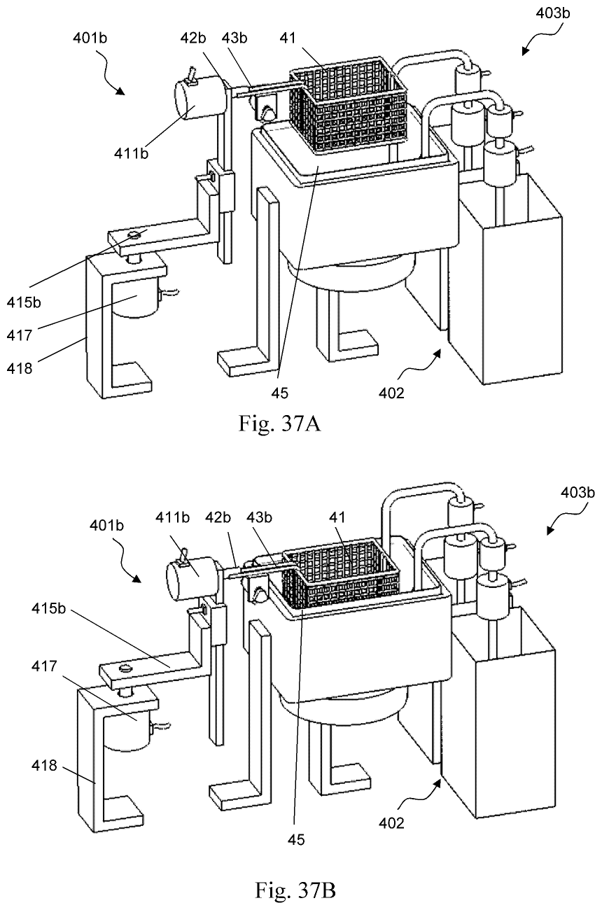

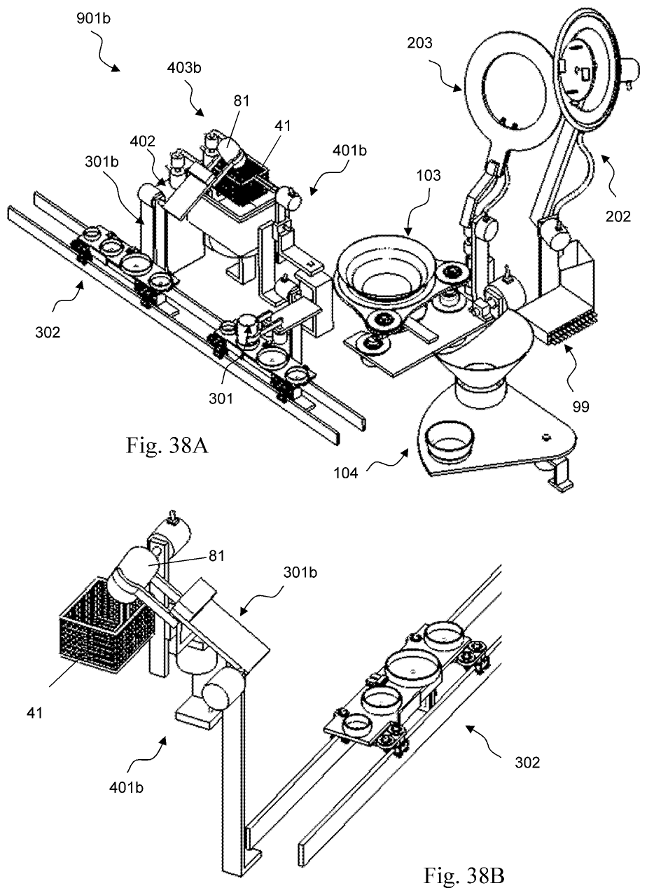

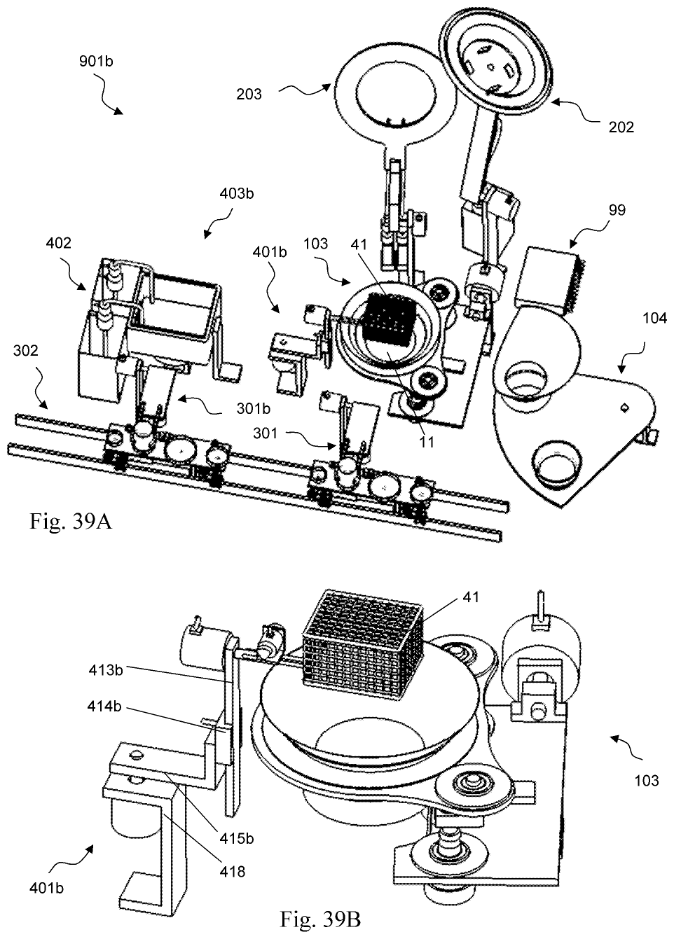

Referring to FIGS. 37A-37B, a cooking apparatus 403b comprises a cooking apparatus 401b and a cooking apparatus 402. When the basket 41 of the cooking apparatus 401b is rotated to the first end-position relative to the sliding member 413b, and the sliding member 413b is moved to the first end-position (i.e., the lower end-position) relative to the support component 415b, and the support component 415b is rotated to the first end-position (i.e., the position of the basket 41 positing right above the bottom of the liquid container 45), the basket 41 is partially immersed in the liquid, as shown in FIG. 37B. When the basket 41 of the cooking apparatus 401b is rotated to the first end-position relative to the sliding member 413b, and when the sliding member 413b is moved to the second end-position (i.e., the upper end-position) relative to the support component 415b, and the support component 415b is rotated to the first end-position(i.e., the position of the basket 41 positing right above the bottom of the liquid container 45) relative to the support component 418, the basket 41 is lifted up from the liquid container 45, as shown in FIG. 37A. The basket 41 may be left at this position for another period of time, during which the vibration device 48b may produce micro-vibrations in the basket 41 as to let the hot liquid attached to the basket 41 to drip into the liquid container 45. Then the motorized mechanism 417 may rotate the support component 415b and the basket 41 to the second position (i.e., the position of the basket 41 right above the cookware 11). Then the motorized mechanism 411b may rotate the basket 41 to dispense a cooked or semi-cooked food from the basket 41 (also see FIG. 39B later).

It should be noted that the cooking apparatus 403b comprises a motion apparatus comprising: a motion mechanism comprising the motorized mechanism 414b, the sliding member 413b, and its connection to the motorized mechanism 411b, said motion mechanism configured to produce a motion in the basket as to allow the basket to be partially immersed in the liquid in the liquid container 45 or to be out of the liquid container 45; a motion mechanism comprising the motorized mechanism 417, the shaft 416, and its connection to the motorized mechanism 414b, said motion mechanism configured to produce a rotation in the basket as to allow the basket to a back-and-forth rotation between two positions which are right above the liquid container 45 and right above the cookware 11; and an unloading mechanism (which is also a motion mechanism) comprising the motorized mechanism 411b, the shaft 42b and its connection to the basket 41, said unloading mechanism configured to produce a motion in the basket 41 as to dispense a semi-cooked food from the basket 41.

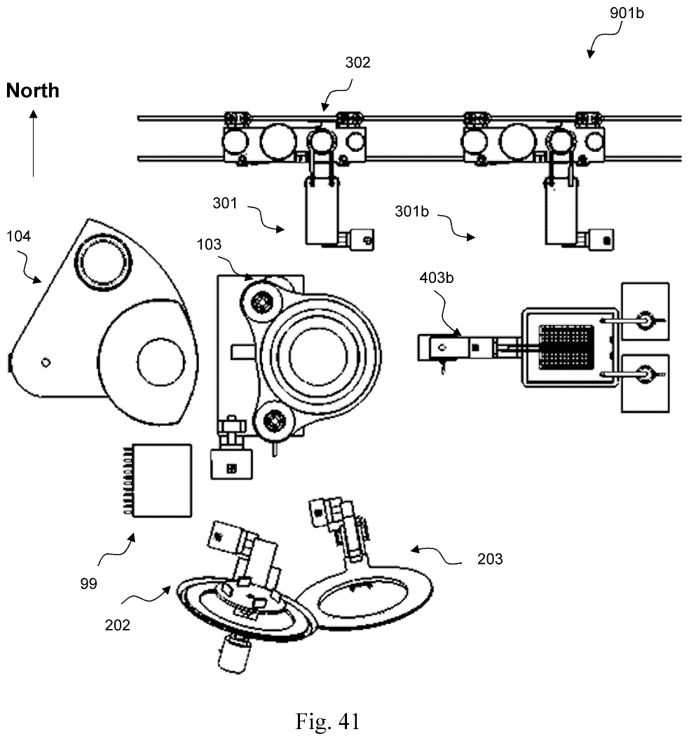

In some embodiments, referring to FIGS. 38A-41, a cooking system 901b is constructed the same as the cooking system 901 except that the cooking apparatus 403 is replaced by the cooking apparatus 403b, wherein the cooking system 901b comprises (from left to right): a receiving apparatus 104; a cookware cleaning mechanism 202; a lid apparatus 203; a cooking apparatus 103; a first ingredient dispensing mechanism 301; a transport system 302; a cooking apparatus 403b; a second ingredient dispensing mechanism 301b; and a computer system 99. The lid apparatus 203 may dispense liquid ingredients into the cookware 11 (as shown in FIG. 7C). The first ingredient dispensing mechanism 301 is positioned next the cooking apparatus 103, as to dispense food ingredients into the cookware 11 of the cooking apparatus 103 (as shown in FIG. 10). The second ingredient dispensing mechanism 301b is a copy of the first ingredient dispensing mechanism 301 with the same part numbers but is positioned next the cooking apparatus 403b. The part numbers in the second ingredient dispensing mechanism 301b are the same as the corresponding part numbers in the first ingredient dispensing mechanism 301.

The cooking apparatus 103 of the cooking system 901b may be referred to as a first cooking apparatus. Said first cooking apparatus comprises: the stirring mechanism 102, referred to as a first motion mechanism; and the unloading mechanism 170, referred to as a second motion mechanism. Said stirring mechanism 102 may move the cookware 11 of the first cooking apparatus 103 as to stir or mix the food or food ingredients in the cookware 11 of the first cooking apparatus 103 during a cooking process. Said unloading mechanism 170 may turn the component 149 of said stirring mechanism 102 and thus move the cookware 11 of said first cooking apparatus 103 as to dispense a cooked food from said cookware 11 to a food container 182 held in the receiving apparatus 104.

The cooking apparatus 403b of the cooking system 901b may be referred to as a second cooking apparatus. It should be noted that said second cooking apparatus 403b comprises a second motion apparatus comprising: the rotation motion mechanism 430, referred to as a third motion mechanism; the vertical motion mechanism 440, referred to as a fourth motion mechanism; and the rotational motion mechanism 450, referred to as a fifth motion mechanism. The fourth motion mechanism may move the basket 41 of the cooking apparatus 403b linearly in the vertical position, when the third and fifth motion mechanisms are not moving. The third motion mechanism is configured to rotate the basket 41 as to dispense a semi-cooked food into the cookware 11 of the first cooking apparatus, when the fourth and fifth motion mechanisms move the support component 413b of said third motion mechanism to a proper position. Said fifth motion mechanism may rotate the support component 415b of said fourth motion mechanism around a fixed vertical axis and thus move the basket 41 between a first position when said basket 41 is above the liquid container 45 of said second cooking apparatus 403b and a second position when said basket 41 is above the cookware 11 of the first cooking apparatus 103.

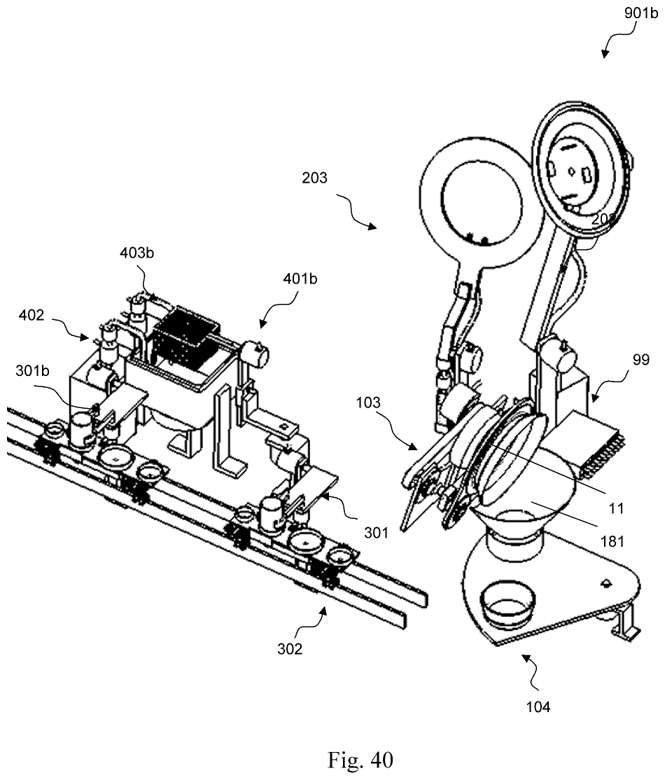

As shown in FIGS. 38A-38B, the gripping devices of the second ingredient dispensing mechanism 301b may be moved to grip an ingredient container 81 containing food ingredients and then rotate the container 81 as to dispense the food ingredients from the container 81 into the basket 41 of the cooking apparatus 401b. Meanwhile the basket 41 is at the first end-position relative to the sliding component 413b; and the sliding component 413b is at the second end-position relative to the support component 415b, and the support component 415b is at the first end-position relative to the support component 418 (or equivalently, relative to the ground). Then, the sliding component 413b is moved down to the first end-position, so that the basket holding the food ingredients may be immersed in a hot liquid in the liquid container 45 of the cooking apparatus 403b. The food ingredients in the basket are cooked in the hot liquid, as to produce a semi-cooked food. Then, the sliding component 413b is moved upward to the second end-position and the basket is lifted up and away from the hot liquid in the liquid container 45. The basket may be left at this position for another period of time, during which the vibration device 48b may produce micro-vibrations in the basket 41 as to let the hot liquid attached to the basket 41 and the semi-cooked food to drip into the liquid container 45. Then, as shown in FIGS. 39A-39B, the semi-cooked food contained in the basket 41 may be dispensed into the cookware 11 when the basket 41 is rotated from the first end-position to the second end-position relative to the sliding component 413b which stays at the second end-position, and when the support component 415b is rotated to the second end-position. Then the semi-cooked food is further cooked by the cooking apparatus 103, possibly together with other ingredients, some of which are dispensed from an ingredient container on a holder of the transport system 302 by the first ingredient dispensing mechanism 301 (also see FIG. 10). Then a cooked food is produced in the cookware 11. Then, as shown in FIG. 40 (also see FIG. 6B), a cooked food may be dispensed into a food container 182 through the funnel 181.

The cookware cleaning mechanism 202 is positioned next to the cooking apparatus 103 and may clean the cookware 11 (also see FIGS. 8B-8C).

The computer system 99 is connected to the mechanisms and devices 161, 16, 13, 172, 188, 212, 226, 234, 253, 344a, 344b, 348, 323, 411b, 414b, 417, 47, 421, 212c and 212d. The computer system 99 is also connected to the transport system 302 as to control the movements of the vehicles of the transport system 302.

In cooking system 901b, the cooking apparatus 103 is positioned near the following mechanisms and apparatuses: the receiving apparatus 104; the cookware cleaning mechanism 202; the lid apparatus 203, the cooking apparatus 403b; the ingredient dispensing mechanism 301 which is next to the transport system 302, and the cooking apparatus 403b. The cooking apparatus 403b is positioned near the second ingredient dispensing mechanism 301b and the cooking apparatus 103.

The computer system 99 comprises a memory. The computer system is configured to store various data in the computer system's memory.

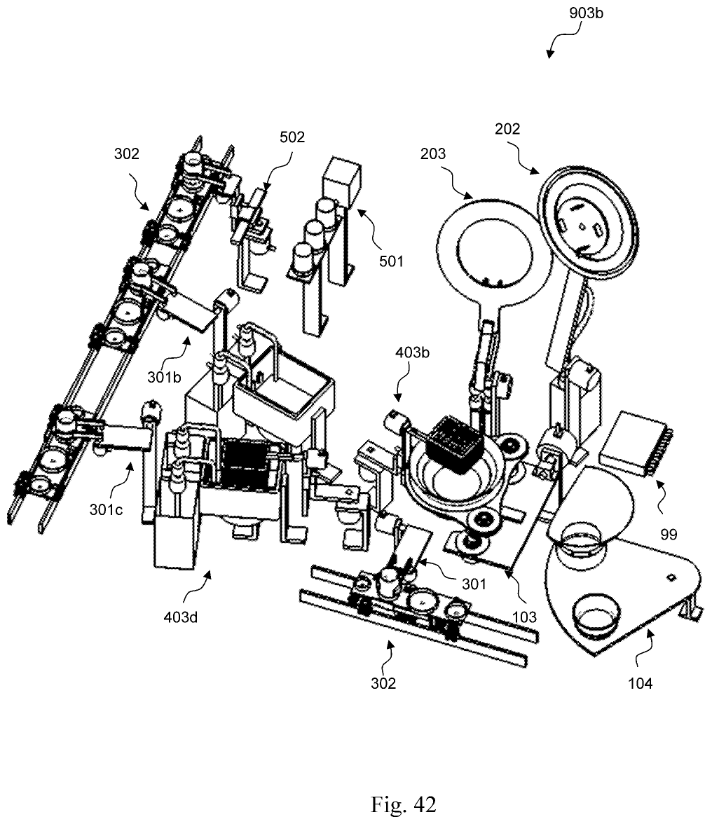

In some embodiments, referring to FIG. 42, a cooking system 903b is constructed similarly as the cooking system 903, wherein the cooking system 903b comprises: a receiving apparatus 104; a cookware cleaning mechanism 202; a lid apparatus 203; a cooking apparatus 103; a first ingredient dispensing mechanism 301; a transport system 302; a cooking apparatus 403b; a cooking apparatus 403d; a second ingredient dispensing mechanism 301b; a third ingredient dispensing mechanism 301c; a storage apparatus 501; a loading mechanism 502; and a computer system 99. The cooking apparatus 403d is a copy of the cooking apparatus 403b with the same part numbers, except that the liquid in the liquid container 45 in the cooking apparatus 403d can be different from the liquid in the liquid container 45 of the cooking apparatus 403b. The lid apparatus 203 may dispense liquid ingredients into the cookware 11 (as shown in FIG. 7C). The first ingredient dispensing mechanism 301 is positioned next the cooking apparatus 103, as to dispense food ingredients into the cookware 11 of the cooking apparatus 103 (as shown in FIG. 10). The second ingredient dispensing mechanism 301b is a copy of the first ingredient dispensing mechanism 301 but is positioned next the cooking apparatus 403b. The part numbers in the second ingredient dispensing mechanism 301b are the same as the corresponding part numbers in the first ingredient dispensing mechanism 301. The third ingredient dispensing mechanism 301c is a copy of the first ingredient dispensing mechanism 301 but is positioned next the cooking apparatus 403d. The part numbers in the third ingredient dispensing mechanism 301c are the same as the corresponding part numbers in the first ingredient dispensing mechanism 301.

The loading mechanism 502 may load an ingredient container 81 containing food ingredients from the storage apparatus 501 to a vehicle 790 in the transport system 302. The vehicle 790 may move to a location next to the cooking apparatuses as to be gripped by the dispensing mechanism corresponding to the cooking apparatus. The timing of arrival of the vehicle 790 at said location is controlled by the computer system 99.

The gripping devices of the dispensing mechanism 301b may be moved to grip an ingredient container 81 containing food ingredients and then rotate the container 81 as to dispense the food ingredients from the container 81 into the basket 41 of the cooking apparatus 403b. Meanwhile the basket 41 of the cooking apparatus 403b is at the first end-position relative to the sliding component 413b of the cooking apparatus 403b; and the sliding component 413b is at the second end-position relative to the support component 415b in the cooking apparatus 403b; and the support component 415b is at the first end-position relative to the support component 418. Then, the sliding component 413b is moved down to the first end-position, so that the basket 41 holding the food ingredients may be immersed in a hot liquid in the liquid container 45 of the cooking apparatus 403b. The food ingredients in the basket 41 are cooked in the hot liquid, as to produce a semi-cooked food. Then, the sliding component 413b is moved upward to the second end-position and the basket 41 is lifted up and away from the hot liquid in the liquid container 45. The basket 41 may be left at this position for another period of time, as to let the hot liquid attached to the semi-cooked food to drip into the liquid container 45. Then, the semi-cooked food contained in the basket 41 may be dispensed into the cookware 11 of the cooking apparatus 103 when the basket 41 is rotated from the first end-position to the second end-position relative to the sliding component 413b and the condition that the sliding component 413b stays at the second end-position and the support component 415b is rotated to the second end-position.

Similarly, the gripping devices of the ingredient dispensing mechanism 301c may be moved to grip an ingredient container 81 containing food ingredients and then rotate the container 81 as to dispense the food ingredients from the container 81 into the basket 41 of the cooking apparatus 403d. Meanwhile the basket 41 of the cooking apparatus 403d is at the first end-position relative to the sliding component 413b of the cooking apparatus 403d; and the sliding component 413b is at the second end-position relative to the support component 415b in the cooking apparatus 403d; and the support component 415b is at the first end-position relative to the support component 418. Then, the sliding component 413b is moved down to the first end-position, so that the basket 41 holding the food ingredients may be immersed in a hot liquid in the liquid container 45 of the cooking apparatus 403d. The food ingredients in the basket 41 are cooked in the hot liquid, as to produce a semi-cooked food. Then, the sliding component 413b is moved upward to the second end-position and the basket 41 is lifted up and away from the hot liquid in the liquid container 45. The basket 41 may be left at this position for another period of time during which the vibration device 48b is configured to produce micro-vibrations in the basket 41 as to let the hot liquid attached to the semi-cooked food to drip into the liquid container 45. Then, the semi-cooked food contained in the basket 41 may be dispensed into the cookware 11 of the cooking apparatus 103 when the basket 41 is rotated from the first end-position to the second end-position relative to the sliding component 413b under the condition that the sliding component 413b stays at the second end-position and the support component 415b is rotated to the second end-position.

Then the semi-cooked foods dispensed from the cooking apparatuses 403b and 403c are further cooked by the cooking apparatus 103, possibly together with other ingredients, some of which are dispensed from an ingredient container on a holder of the transport system 302 by the first ingredient dispensing mechanism 301 (also see FIG. 10). Then a cooked food is produced in the cookware 11. Then, as shown in FIG. 32 (also see FIG. 6B), a cooked food may be dispensed into a food container 182 through the funnel 181.

The cookware cleaning mechanism 202 is positioned next to the cooking apparatus 103 and may clean the cookware 11 (also see FIGS. 8C-8D).

The computer system 99 is connected to the mechanisms and devices 161, 16, 13, 172, 188, 212, 226, 234, 253, 344a, 344b, 348, 323, 411b, 414b, 417, 47, 421, 212c, 212d, 501 and 502. The computer system 99 is also connected to the transport system 302 as to control the movements of the vehicles of the transport system 302.

In cooking system 903b, the cooking apparatus 103 is positioned near the following mechanisms and apparatuses: the receiving apparatus 104; the cookware cleaning mechanism 202; the lid apparatus 203, the cooking apparatus 403b; the ingredient dispensing mechanism 301 which is next to the transport system 302, and the cooking apparatus 403d. The cooking apparatus 403b is positioned near the second ingredient dispensing mechanism 301b and the cooking apparatus 103. The cooking apparatus 403d is positioned near the third ingredient dispensing mechanism 301c and the cooking apparatus 103.

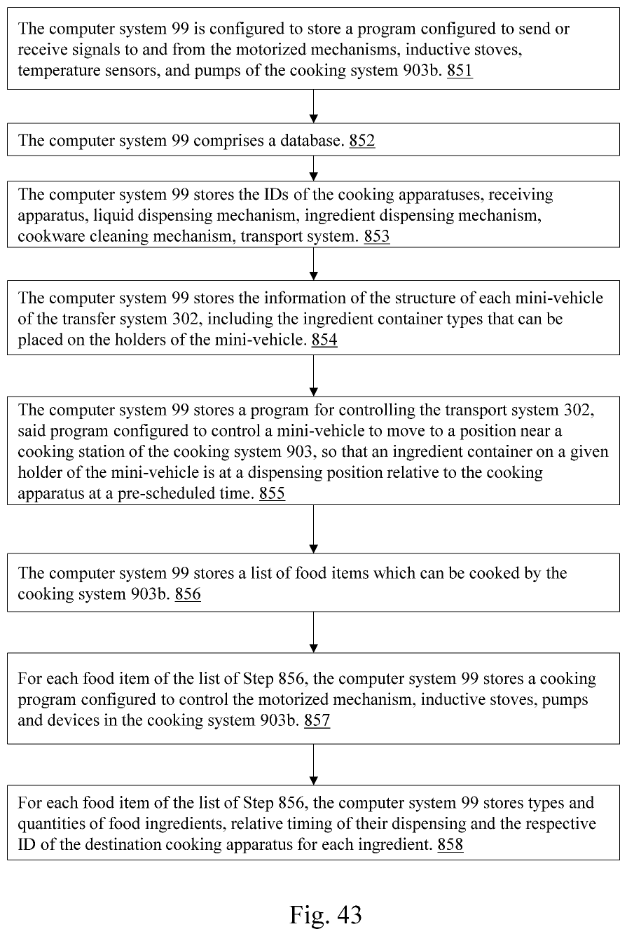

Referring to FIG. 43, the following tasks are performed by the computer system 99 prior to the operation of the cooking system 903b.

In Step 851, the computer system 99 stores (in the computer system's memory) a program, configured to send or receive signals to and from the motorized mechanisms, inductive stoves, temperature sensors and pumps of the cooking system 903b. The signals are used to control the operations of the motorized mechanisms, inductive stoves and pumps, or to communicate information from the temperature sensors to the computer system 99.

In Step 852, a database is installed in the computer system 99.

In Step 853, each of the cooking apparatuses, receiving apparatus, liquid dispensing mechanisms, ingredient dispensing mechanisms, cookware cleaning mechanism, transport system is assigned a unique ID. The computer system 99 stores the IDs of these apparatuses and mechanisms.

In Step 854, the computer system 99 stores the information of the structure of each vehicle of the transport system 302, including the ingredient container types that can be placed on the holders of the vehicle.

In Step 855, the computer system 99 stores a program for controlling the transport system 302. The program is used to control a vehicle so the vehicle may move and stop at a pre-scheduled time at a position near a cooking apparatus of the cooking system 903b, where a container on a given holder of the vehicle is at a dispensing position relative to the cooking apparatus.

In Step 856, the computer system 99 stores a list of food items which may be cooked by the cooking system 903b.

In Step 857, for each food item in the list of Step 856, the computer system 99 stores a cooking program configured to control the motorized mechanism, inductive stoves, pumps and devices in the cooking system 903b.

In Step 858, for each food item in the list of Step 856, the computer system 99 stores types and quantities of food ingredients, relative timing of their dispensing and the respective ID of the destination cooking apparatus for each ingredient to be dispensed into; wherein the relative timing refers to the timing relative to the timing of the program of Step 857 corresponding to the food item. Food ingredients contained in a container is to be dispensed into a basket or cookware in the destination cooking apparatus.

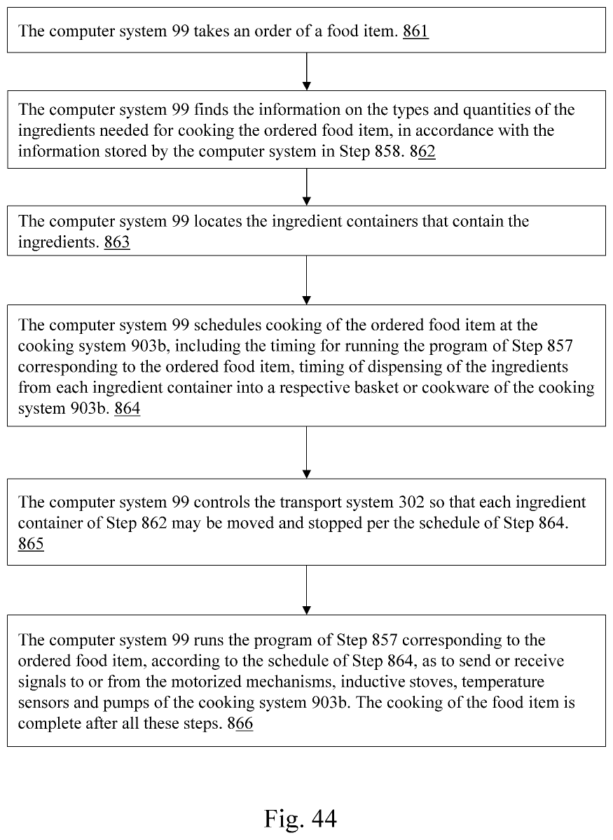

Referring to FIG. 44, the following tasks are routinely performed by the computer system 99 during the operation of the cooking system 903b.

In Step 861, the computer system 99 takes an order of a food item. The order may be placed by a human either at the computer system 99, or at a computer which sends the order to the computer system 99.

In Step 862, for the ordered food item of Step 861, the computer system 99 finds the information on the types and quantities of the ingredients needed for cooking the ordered food item. Such information was stored by the computer system 99 in Step 858.

In Step 863, the computer system 99 locates the ingredient containers that contain the food ingredients found in Step 862. The ingredients may be dispensed from some larger containers into said ingredient containers. Alternatively, ingredients may already be in the ingredient containers, and their locations had been stored in the memories of the computer system 99.

In Step 864, the computer system 99 schedules the cooking of the ordered food item at cooking system 903b. The schedule includes the timing for running the program of Step 857 corresponding to the ordered food item. The schedule also includes the timing of dispensing of the ingredients from each ingredient container into a respective basket or cookware of the cooking system 903b, in accordance to the stored information by the computer system 99 in Step 858.

In Step 865, the computer system 99 controls the transport system 302 so that each ingredient container of Step 862 may be moved and stopped per the schedule of Step 864.

In Step 866, The computer system 99 runs the program of Step 857 corresponding to the ordered food item, according to the schedule of Step 864, as to send or receive signals to or from the motorized mechanisms, inductive stoves, temperature sensors and pumps of the cooking system 903b.

After all these steps, the cooking of the food item, including dispensing of the cooked food to a food container, is complete.

In some applications, the liquid in the liquid container 45 of the cooking apparatus 403b of the cooking system 903b may comprise cooking oil, while the liquid in the liquid container 45 of the cooking apparatus 403d may comprise water.

For the purpose of the present patent application, a motorized mechanism can describe any mechanism configured to produce a relative motion. A motorized mechanism can be powered by electricity, oil or other energy sources. A motorized mechanism may comprise a motor.

A motor may be an AC or DC motor, stepper motor, servo motor, inverter motor, pneumatic or hydraulic motor, etc. A motor may optionally further comprise a speed reducer, encoder, and/or proximity sensor.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination.

A rigid component described in the present patent application can be any type of solid component which has some degree of rigidity in an application, and there is no strict or quantitative requirement for the degree of rigidity. It should be noted that there is no perfect rigid component in our world, as there are always elastic, thermal, and other deformations in any physical subject. A rigid component may comprise one or more of the following: a bar, a tube, a beam, a plate, a board, a frame, a structure, a bearing housing, a shaft. A rigid component can be made by metal such as steel or aluminum, or a mixture of metals, an alloy, a reasonably rigid plastic, a wood, or by other materials, or by a combination of different types of materials.

Similarly, a rigid connection of two or more components can be a connection which has some degree of rigidity in an application, and there is no strict quantitative requirement for the degree of rigidity. A rigid connection may be a welding of two or more metal components. A rigid connection may be a bolting of two or more components; and so on. Clearly, a typical connection of a shaft and a bearing housing by a bearing (and accessories), for example, is not a rigid connection, since the shaft can rotate relative to the bearing housing.

A support component described in the present patent application can be a rigid component of any type, or a plurality of rigid components which are rigidly connected to each other. A support component may be moved or fixed relative to the ground. A link described in the present patent application can be a rigid component of any shape, or a plurality of rigid components which are rigidly connected to each other.

Most common bearings are ball bearings and roller bearings. However, a bearing in the present patent application can be of any type.

It should be noted that the drawings in the present patent application are schematic and may not be well scaled. The distances between various mechanisms and apparatuses may not be drawn in good scale. The 3-dimensional positioning of various mechanisms and apparatuses in a cooking system may be done in various other ways.

In the cooking systems 901, 901b, 902, 903 and 903b, the ingredient dispensing mechanism 301, 301b, 301c and 301d may be configured differently. The container holders 785a of the transport system 302 which are next to different ingredient dispensing mechanisms may be configured to have different sizes. The ingredient containers 81 on different holders may be configured to have different sizes. The transport system 302 may comprise two or more sub-systems which are not connected with each other, and the vehicles may be configured differently on different sub-systems.

On the other hand, the first ingredient dispensing mechanism 301 and the second ingredient dispensing mechanism 301b may be combined into one, using robot arms and other more complex mechanisms. Our mechanisms stand out as most economical.

The first lid apparatus 203 and the second lid apparatus 203b in the cooking system 902 may be configured differently. On the other hand, they can be combined into a single mechanism which comprises a motion mechanism configured to move the liquid pipes as to reach two different cookware.

It should also be noted that the first cooking apparatus 103 and the second cooking apparatus 103b in the cooking system 902 may be configured differently. The sizes and shapes of the cookware 11 can be different for different cooking apparatus. Likewise, the first cookware cleaning mechanism 202 and the second cookware cleaning mechanism 202b in the cooking system 902 may be configured differently.

Only a few examples and implementations are described. Other implementations, variations, modifications and enhancements to the described examples and implementations may be made without deviating from the spirit of the present invention. For example, the term cookware is used to generally refer to a device for containing or holding food ingredients during cooking. For the purpose of present patent application, a cookware can be a wok, a pot, a pan, a basket, a bowl, a container, a board, a rack, a net, or any object used to contain or otherwise hold food or food ingredients during a cooking process. The cooking also is not limited to any particular ethnic styles. The cooking may include but is not limited to: frying (including stir frying), steaming, boiling, roasting, baking, smoking, microwaving etc. The cooking apparatus may or may not use a heater.

Similarly, a food container, ingredient container, or container, can be a bowl, a plate, a cup, a jar, a bottle, a flat board, a basket, a net, a wok, a pan, or any object used to contain or otherwise hold a food or food ingredients. A container can have a rather arbitrary geometric shape.

In our patent application, a computer system may or may not comprise a network. A computer system may be a single computer in some simpler applications.

For the purpose of the present patent application, a connection of a computer system (which may be a single computer) and an electric or electronic component may comprise a wired and/or wireless connection between computer system and the electric or electronic device, as to allow the computer to communicate with said electric or electronic component. A connection of a computer system and a mechanism or apparatus may comprise a wired and/or wireless connection between the computer system and some (or all) of the electric or electronic components of the mechanism or apparatus as to allow the computer to communicate with said electric or electronic components.

What is claimed is:

1. A cooking system configured to cook food, said cooking system comprising:
a computer system comprising one or more computers;
a first cooking apparatus comprising:
a first cookware configured to contain or otherwise hold food or food ingredients; and
a first motion apparatus comprising:
a first motion mechanism configured to move the first cookware under the control of the computer system;
a second motion mechanism;
wherein said first motion apparatus configured to move the first cookware as to dispense a cooked food from the first cookware to a container under the control of the computer system;
a second cooking apparatus comprising:
a second cookware, configured to contain or otherwise hold food or food ingredients; and
a second motion apparatus comprising a third motion mechanism configured to move the second cookware;
wherein said second motion apparatus is configured to move the second cookware as to dispense food or food ingredients from the second cookware to the first cookware under the control of the computer system; and
a first ingredient dispensing mechanism configured to dispense food ingredients into the first cookware.

2. The cooking system of claim 1, wherein the first ingredient dispensing mechanism is configured to dispense virtually all food ingredients of a container at once.

3. The cooking system of claim 1, further comprising a second ingredient dispensing mechanism, configured to dispense food ingredients into the second cookware.

4. The cooking system of claim 1, further comprising a cookware cleaning mechanism configured to clean the first cookware, wherein the computer system is configured to control the cookware cleaning mechanism.

5. The cooking system of claim 1, further comprising a storage apparatus configured to store containers of food ingredients.

6. The cooking system of claim 1, further comprising a transport system configured to move a container of food ingredients.

7. The cooking system of claim 6, wherein the transport system comprises a vehicle configured to move a container of food ingredients.

8. The cooking system of claim 7, further comprising a loading mechanism configured to load a container of food ingredients to a vehicle.

9. The cooking system of claim 1, further comprising a motorized mechanism configured to move a container of cooked food.

10. The cooking system of claim 1, wherein said second motion mechanism of the first motion apparatus comprises a sub-mechanism that produces a relative rotational motion between two members.

11. The cooking system of claim 1, wherein said first motion mechanism of the first motion apparatus is configured to move the first cookware as to stir or mix the food or food ingredients in said cookware during a cooking process.

12. The cooking system of claim 1, wherein said first motion mechanism of the first motion apparatus comprises: a first sub-mechanism configured to produce a relative rotation in two members of said motion mechanism; and a second sub-mechanism configured to allow two members of said motion mechanism to rotate relative to each other.

13. The cooking system of claim 1, wherein said first motion mechanism of the first motion apparatus comprises a first shaft and a second shaft.

14. The cooking system of claim 13, wherein said first shaft and second shaft are rigidly connected to each other.

15. The cooking system of claim 1, wherein said third motion mechanism of said second cooking apparatus is configured to move the second cookware as to stir or mix the food or food ingredients held in said cookware during a cooking process.

16. A cooking system configured to cook food, said cooking system comprising:
a computer system comprising one or more computers;
a first cooking apparatus comprising:
a first cookware configured to contain or otherwise hold food or food ingredients;
a first motion apparatus comprising:
a first motion mechanism configured to move the first cookware; and
a second motion mechanism;
wherein said first motion apparatus is configured to move the first cookware as to dispense a cooked food from the first cookware to a container under the control of the computer system;
a second cooking apparatus comprising:
a second cookware comprising a porous container, said porous container being configured to contain or otherwise hold food or food ingredients;
a liquid container configured to contain a liquid;
a heater configured to heat the liquid contained in said liquid container;
a second motion apparatus comprising a motion mechanism;
wherein said second motion apparatus is configured to move the second cookware as to place the food or food ingredients held by the second cookware into the liquid of the liquid container under the control of the computer system;
wherein said second motion apparatus is configured to move the second cookware as to dispense food or food ingredients from the second cookware to the first cookware under the control of the computer system under the control of the computer system; and
an ingredient dispensing mechanisms configured to dispense food ingredients into the first cookware.

17. The cooking system of claim 16 wherein said porous container is configured to be a basket.

18. The cooking system of claim 16, further comprising a cookware cleaning mechanism configured to clean the first cookware, wherein the computer system is configured to control the cookware cleaning mechanism.

19. The cooking system of claim 16, wherein said motion mechanism of the second motion apparatus is configured to produce a linear motion.

20. The cooking system of claim 16, wherein said first motion mechanism of the first motion apparatus is configured to move the first cookware as to stir or mix the food or food ingredients in said cookware during a cooking process.
